(19) United States
(12) Patent Application Publication
(10) Pub. No.: US 2014/0131617 A1
(43) Pub. Date: May 15, 2014

(54) Single-Phase Lithium-Deficient Lithium Multicomponent Transition Metal Oxide Having a Layered Crystal Structure and a Method for Producing the Same

(71) Applicants: Sei Ung Park, Yuseong-gu Daejeon (KR); Ju Suk Ryu, Seo-gu Daejeon (KR); Kyu Ho Song, Seo-gu Daejeon (KR); Si Jin Oh, Jeollabuk-do (KR); Dong Suek Lee, Yuseong-gu Daejeon (KR); Seong Jae Lim, Seo-gu Daejeon (KR); Ki Taeg Jung, Yuseong-gu Daejeon (KR); Kyoo Seung Han, Busanjin-gu Busan (KR)

(72) Inventors: Sei Ung Park, Yuseong-gu Daejeon (KR); Ju Suk Ryu, Seo-gu Daejeon (KR); Kyu Ho Song, Seo-gu Daejeon (KR); Si Jin Oh, Jeollabuk-do (KR); Dong Suek Lee, Yuseong-gu Daejeon (KR); Seong Jae Lim, Seo-gu Daejeon (KR); Ki Taeg Jung, Yuseong-gu Daejeon (KR); Kyoo Seung Han, Busanjin-gu Busan (KR)

(21) Appl. No.: 14/130,573

(22) PCT Filed: Jul. 9, 2012
(86) PCT No.: PCT/KR2012/005412

§ 371 Date: Jan. 2, 2014

(30) Foreign Application Priority Data
Jul. 20, 2011 (KR) 10-2011-0072132

(51) Int. Cl. H01M 4/505; H01G 11/50; H01M 4/525

(52) U.S. Cl. CPC H01M 4/505; H01M 4/525; H01G 11/50
USPC 252/182.1

(57) ABSTRACT

The present invention relates to a single-phase lithium-deficient lithium multicomponent transition metal oxide having a layered crystal structure represented by the formula Li₁₋ₐM1_{1-x-y-z}M2ₓM3_{y}M4_{z}O₂, wherein M1 is one or more transition metals having an oxidation number of +3; M2 is one or more transition metals having an oxidation number of +4; M3 is one or more transition metals having an oxidation number of +5; M4 is one or more elements having an oxidation number of +2; x+2y−z>0; x+y+z<1; 0<a<1; 0<x<0.75; 0≦y<0.6; and 0≦z<0.3.

### BACKGROUND

1. Technical Field

The present invention relates to a single-phase lithium-deficient lithium multicomponent transition metal oxide having a layered crystal structure and a method for producing the same.

2. Background Art

Lithium secondary batteries exhibit a higher energy density and a higher operating potential than other secondary batteries, such as nickel-cadmium batteries (Ni//Cd), nickel metal hydride batteries (Ni//MH), etc., and have such advantages as long charge/discharge lifetime and low self-discharge rate. Therefore, they have been used as a power source for portable electrical and electronic appliances including cellular phones, laptop computers, game machines, wireless cleaners, etc. In recent days, the market has been rapidly expanded to lithium secondary batteries having high energy density, high capacity, high power and long lifetime properties for portable digital-convergence electronic information and communication appliances, in which various functions are converged in one electronic appliance, electric bicycles, electrically powered scooters, service robots, electric cars, power storage equipment, etc. Particularly, as the sizes of batteries increase for use in transportation systems or power storage equipment, high stability and lower prices are becoming more in demand. Efforts to satisfy such requirements have been concentrated on replacing common cathode-active materials with other transition metal compounds.

One example of such efforts is to make lithium multicomponent transition metal oxides, such as LiNi₁₋ₓCoₓO₂, LiNi₁₋ₓMnₓO₂, LiNi_{1-x-y}MnₓCo_{y}O₂, LiNi_{1-x-y}MnₓFe_{y}O₂, LiNi_{1-x-y}MnₓAl_{y}O₂, etc., by replacing expensive cobalt in lithium cobalt oxides having a layered crystal structure, which have been most widely used as cathode-active material, with relatively inexpensive nickel, manganese, iron, aluminum, etc. Such lithium multicomponent transition metal oxides are classified depending on the kinds and number of substituted transition metals and the substitution ratios, but can also be classified by phase-transition forms which arise upon charge/discharge. Changes in the oxidation number of transition metals upon charge and discharge are related to the intercalation and deintercalation of lithium ions having a charge of +1 for the electroneutrality of the cathode-active material. Therefore, as the range of the oxidation number of reversibly changeable transition metals becomes wider and as the amount of lithium ions which can be reversibly intercalated and deintercalated becomes greater (that is, as the range of changes in the compositional ratio of Li becomes greater), the charge capacity increases. It is known that Li₁₋ₓCoO₂ can be reversibly charged and discharged without phase transitions only in the range of 0≦x<0.5, whereas Li₁₋ₓNi_{1/3}Mn_{1/3}Co_{1/3}O₂ can be reversibly charged and discharged without phase transitions in the range of 0≦x<0.8, and so can Li₁₋ₓNi_{0.5}Mn_{0.5}O₂ in the range of 0≦x≦1. Due to this difference in the range of changes in the compositional ratio, lithium multicomponent transition metal oxides achieve such battery properties as high energy density, high capacity, etc.

The oxidation numbers of transition metals included in lithium multicomponent transition metal oxides increase or decrease upon charge and discharge. However, not all of the oxidation numbers of transition metals included therein increase or decrease depending on charge/discharge. For example, in the case of LiNi_{1-x-y}MnₓCo_{y}O₂ comprised of low-spin Ni²⁺, Co³⁺, and Mn⁴⁺, the ion Ni²⁺ participates in the early stage of charge and Co³⁺ participates in the ending stage of charge. On the other hand, Mn⁴⁺ does not participate in charge/discharge but contributes to the stability of the entire layered crystal structure.

The reason why LiNi_{1-x-y}MnₓCo_{y}O₂ is comprised of low-spin Ni²⁺, Co³⁺, and Mn⁴⁺ can be understood through the comparison of the crystal field stabilization energy of transition metal ions and first principles calculation. If the electroneutrality of a compound is satisfied, nickel and manganese ions generally prefer the electron configuration of Ni²⁺ and Mn⁴⁺ to Ni³⁺ and Mn³⁺. However, if the average oxidation number of nickel, manganese, and cobalt is not +3, the chemical formula LiNi_{1-x-y}MnₓCo_{y}O₂ does not satisfy electroneutrality and, therefore, cannot exist.

Nickel/manganese/cobalt oxides having an average oxidation number less than +3 can exist in the following four forms.

The first compounds contain impurities such as NiO and Li₂MnO₃. Such impurities have no reversible electrochemical activity and thus deteriorate battery properties.

The second compounds contain Ni²⁺ in an excessive amount to satisfy electroneutrality, and sites of Li⁺ are occupied by excessive Ni²⁺, that is, the relevant lithium nickel/manganese/cobalt oxides contain excessive nickel, but not at a high ratio. They can be represented by the chemical formula (Li₁₋ₐNiₐ)[Ni_{1-x-y}MnₓCo_{y}]O₂, but are difficult to be regarded as compounds having a single-phase layered crystal structure because they have a three-dimensional crystal structure in proportion to the excessiveness of nickel. Such compounds do not have good electrochemical properties like the known compound Li₁₋ₓNi₁₊ₓO₂. In the above formula (Li₁₋ₐNiₐ)[Ni_{1-x-y}MnₓCo_{y}]O₂, all ions in the parentheses sit in the octahedral sites between the layers of the transition metal oxides, and all ions in the square brackets take the octahedral sites inside the layers of transition metal oxides. Here, the expression “high ratio of nickel” means that the sum of moles of nickel, manganese, and cobalt present inside the layers of transition metal oxides is 1 while the ratio of nickel is higher than the ratios of manganese and cobalt. Further, the expression “nickel in excess” means that the sum of moles of nickel, manganese, and cobalt present inside the layers of transition metal oxides is 1 while nickel additionally exists in the octahedral sites between the layers of transition metal oxides, and thus the molar sum of nickel, manganese, and cobalt included in the lithium nickel/manganese/cobalt oxide exceeds 1.

The third compounds are lithium-excess, oxygen-deficient lithium nickel/manganese/cobalt oxides wherein Li⁺ occupies the sites of transition metal ions in the layers of transition metal oxides. These compounds can be represented by the chemical formula Li[Li_{δ}Ni_{1-x-y-δ}MnₓCo_{y}]O_{2-θ}. They do not have a perfect layered crystal structure, but come to have a network crystal structure in proportion to the molar sum of the excessive lithium and the deficient oxygen.

The fourth compounds are Li₂MO₃—LiMO₂ or Li[LiₓM₁₋ₓ]O₂—LiMO₂, which is a mixture or complex. They are referred to as lithium-excess compounds, not single-phase lithium multicomponent transition metal oxides having a layered crystal structure. Li[LiₓM₁₋ₓ]O₂—LiMO₂ looks like said third compounds but is a mixture or a complex having different crystal regions, unlike the third compounds which are solid solutions. A further difference is that the third compounds have oxygen deficiency. Since Li₂MO₃ reacts as shown below, it can temporarily have electrochemical activity but does not participate in stable and reversible charge and discharge.

Li₂MO₃→2Li⁺+MO₂+½O₂+2e⁻

Since said four kinds of compounds comprise impurities, mixtures, or complexes which do not participate in reversible charge/discharge, batteries comprised of such compounds do not have good electrochemical properties. For example, lithium multicomponent transition metal oxides having a single phase and a layered crystal structure have a theoretical discharge capacity on the level of 278 mAh/g, whereas the actual discharge capacity of the conventional lithium nickel/manganese/cobalt oxides is on the level of 180 mAh/g. Although some compounds exhibit an early discharge capacity above 200 mAh/g, such a discharge capacity is not maintained during a long charge/discharge period due to the presence of impurities, mixtures, or complexes having no reversible electrochemical activity.

In cases where low-spin Ni²⁺, Co³⁺, and Mn⁴⁺ are maintained while the mole number of nickel is higher or lower than that of manganese, the chemical formula LiNi_{1-x-y}MnₓCo_{y}O₂ does not satisfy the requirement of electroneutrality, and thus cannot exist. Electroneutrality can be satisfied only when the compound has the apparent chemical formula Li₁₋ₐNi_{1+a-x-y}MnₓCo_{y}O₂, Li_{1-δ}Ni_{1-x-y}MnₓCo_{y}O₂, or Li_{1-θ}Ni_{1-x-y}MnₓCo_{y}O₂. Here, the value of δ representing an excessive amount of nickel should be the same as 1−2x−y, which is the molar difference between nickel and manganese, and the value of θ, which denotes a deficient amount of lithium, should be the same as 2x+y−1, which is a molar difference between manganese and nickel.

Meanwhile, since the oxidation number of oxygen is −2 and that of lithium is +1, a compound which contains lithium and oxygen in the ratio of 1:2 satisfies electroneutrality only when the average oxidation number of the transition metals is +3 in any combination of transition metals including the combinations of Ni, Mn, and Co. Therefore, in the case of LiNi_{1-x-y}MnₓCo_{y}O₂, the following relationship must be satisfied in order to satisfy electroneutrality:

2(1−x−y)+4x+3y=2+2x+y=3 (average oxidation number of transition metals)

2x+y=1

For the chemical formula LiNi_{1-x-y}MnₓCo_{y}O₂, said relationship (1=2x+y) can be derived only when the molar ratio of nickel (1−x−y) is the same as that of manganese (x), i.e., 1−x−y=x. From this, it is confirmed that if the molar ratios of nickel and manganese in LiNi_{1-x-y}MnₓCo_{y}O₂ are not identical, LiNi_{1-x-y}MnₓCo_{y}O₂ cannot satisfy the requirement for electroneutrality.

To prepare a battery having high energy density and high capacity, the proportion of nickel participating in charge/discharge in the cathode active material must be higher than that of manganese not participating in charge/discharge. In that case, the molar ratio of lithium becomes always greater than 1. For example, if the ratio Ni:Mn:Co is 0.5:0.3:0.2, the apparent chemical formula Li_{1.2}Ni_{0.5}Mn_{0.3}Co_{0.2}O₂ is derived if only the electron configuration of low-spin Ni²⁺, Co³⁺, Mn⁴⁺ and electroneutrality are considered, but said compound cannot exist in reality. As another example, where the ratio Ni:Mn:Co is 0.6:0.2:0.2, the apparent chemical formula of Li_{1.4}Ni_{0.6}Mn_{0.2}Co_{0.2}O₂ is derived if only the electron configuration of low-spin Ni²⁺, Co³⁺, Me and electroneutrality are considered, but said compound cannot exist, either. As another example, if the ratio Ni:Mn:Co is 0.8:0.1:0.1, the apparent chemical formula Li_{1.7}Ni_{0.8}Mn_{0.1}Co_{0.1}O₂ is derived if only the electron configuration of low-spin Ni²⁺, Co³⁺, Mn⁴⁺ and electroneutrality are considered, but said compound cannot exist.

The reason why said compounds cannot exist is that no space where excessive lithium ions can sit is present in a single-phase layered crystal structure. Therefore, if the mole number of Ni²⁺ is higher than that of Mn⁴⁺, a compound is present as a mixture or complex referred to as a lithium-excess compound, rather than as a single-phase lithium multicomponent transition metal oxide having a layered crystal structure.

Although some prior art references disclose lithium multicomponent transition metal oxides having a layered crystal structure, such oxides are different from the single-phase compounds of the present invention in that they do not have a single phase unless the mole number of Ni²⁺ is lower than, or the same as, the mole number of Mn⁴⁺.

For instance, when the average oxidation number is lower than +3, a compound exists as a solid solution, mixture, or complex referred to as a lithium-excess compound, not as a single-phase lithium multicomponent transition metal oxide having a layered crystal structure. Such a compound is different from the lithium-deficient compounds of the present invention which have a single phase and a layered crystal structure.

As another example, if a compound which can be represented by the chemical formula LiMO₂ (M is two or more transition metals) is a single-phase lithium multicomponent transition metal oxide having a perfect layered crystal structure, it must have the crystal structure of the space group R-3m. However, the lithium multicomponent transition metal oxides described in some prior art references have the crystal structure of the space group P3₁12. In the case of the space group R-3m, the oxygen layer has a cubic dense structure in the form of ABCABC. On the other hand, in the case of the space group P3₁12, the oxygen layer has an ABACABAC structure, which is a combination of a cubic dense structure and a hexagonal dense structure, rather than a single cubic dense structure or a single hexagonal dense structure. Therefore, the lithium multicomponent transition metal oxides (the space group P3₁12) described in some prior art references are different in crystal structure from the lithium-deficient, lithium multicomponent transition metal oxides (the space group R-3m) of the present invention.

Moreover, when compared with known lithium multicomponent transition metal oxides, the lithium-deficient, lithium multicomponent transition metal oxides of the present invention are also different therefrom in that the oxidation numbers of transition metals are different and they are non-stoichiometric and lithium-deficient.

In most of the known lithium multicomponent transition metal oxides having a layered crystal structure, the average oxidation number of transition metals is +3 or less than +3. For example, U.S. Pat. No. 6,964,828 and European Patent EP-2-101-370 relate to the lithium multicomponent transition metal oxides represented by Li[M¹₍₁₋ₓ₎Mnₓ]O₂ (0<x<1, M¹ is one or more transition metals other than Cr), Li[Li_{(1-2y)/3}M²_{y}Mn_{(2-y)/3}]O₂ (0<y<0.5, M² is one or more transition metals other than Cr), Li[Li_{(1-y)/3}M³_{y}Mn_{(2-2y)/3}]O₂ (0<y<0.5, M³ is one or more transition metals other than Cr), Li[M⁴_{y}M⁵_{1-2y}Mn_{y}]O₂ (0<y<0.5, M⁴ is a transition metal other than Cr, M⁵ is a transition metal other than Cr and is different from M⁴).

Further, although there have been known lithium multicomponent transition metal oxides containing transition metals having an average oxidation number not less than 3, they are different from the single phase, lithium-deficient compounds of the present invention in that they are mixtures or complexes, not single-phase compounds, and in specific compositions. For example, U.S. Pat. No. 7,468,223 relates to a mixture or a complex represented by the formula xLiMO₂.(1−x)Li₂M′O₃ (0<x<1, M is one or more transition metal ions having an average oxidation number of +3, and M′ is one or more transition metal ions having an average oxidation number of +4). Similarly, US Patent Application Publication No. US200910155691 relates to a mixture or a complex represented by the formula xLiA_{α′}Ni_{α}Co_{β}Mn_{γ}Mo_{δ}M_{y}O₂.(1−x)Li₂Mn_{γ}M″_{φ}O₃ (A is Na, K or a mixture of Na and K; M is Mg, Zn, Al, Ga, B, Zr, Si, Ti, Nb, W, or a mixture of any two or more thereof; 0≦x≦1; 0.01≦α′≦0.1; 0.01≦α≦1; 0≦β≦1; 0.01≦γ≦1; 0≦δ≦0.2; 0≦φ≦1; and 0≦y≦0.15).

Korean Patent Application Laying-Open No. 10-2010-0030612 discloses lithium multicomponent transition metal oxides having a layered crystal structure, which comprise a mixture of transition metals Ni, Mn, and Co, wherein the average oxidation number of the transition metals is greater than +3, and the oxides satisfy the requirements for 1.1<m(Ni)/m(Mn)<1.5 and 0.4<m(Ni²⁺)/m(Mn⁴⁺)<1. However, the compounds disclosed in said Korean patent application comprise a large quantity of nickel having an oxidation number of +2, and are far inferior to the compounds of the present invention in efficiency as electrode materials of lithium secondary batteries.

Japanese Patent Application Laying-Open No. 2005-332691 relates to the A multicomponent transition metal oxides represented by AₓNi_{1-z}M_{z}O₂, which is obtained by removing A via charge/discharge and acid treatment of ANi_{1-z}M_{z}O₂. However, there is no information about the precursor ANi_{1-z}M_{z}O₂. In this regard, common ANi_{1-z}M_{z}O₂, wherein the oxidation number of Ni is not selectively controlled in accordance with the ratio of z, is a mixture or a complex, not a single-phase compound; accordingly, it is different from the single phase, lithium-deficient lithium multicomponent transition metal oxide of the present invention having a layered crystal structure.

### SUMMARY

### Technical Problem

Briefly stated, a single-phase lithium-deficient lithium multicomponent transition metal oxide having a layered crystal structure, which can provide batteries with high energy density, high capacity, high stability and long lifetime oxides as electrode-active material when compared with prior art lithium multicomponent transition metal, and a method for preparing the same are provided.

A single-phase lithium-deficient lithium multicomponent transition metal oxide having a layered crystal structure provides batteries with good properties including high energy density, high capacity, high stability and long lifetime.

The compound is a single-phase lithium-deficient lithium multicomponent transition metal oxide having a layered crystal structure represented by the following chemical formula 1:

Li₁₋ₐM1_{1-x-y-z}M2ₓM3_{y}M4_{z}O₂ (1)

In the above formula, M1 is one or more transition metals having an oxidation number of +3; M2 is one or more transition metals having an oxidation number of +4; M3 is one or more transition metals having an oxidation number of +5; M4 is one or more elements having an oxidation number of +2; x+2y−z>0; x+y+z<1; 0<a<1; 0<x<0.75; 0≦y<0.6; and 0≦z<0.3.

In addition, the present invention provides a method for preparing a single-phase lithium-deficient lithium multicomponent transition metal oxide which has a layered crystal structure and is represented by the above chemical formula 1, which method comprises the following steps:

(a) a step of preparing a first aqueous solution in which transition metals are dissolved, and a second aqueous solution in which an alkalizing agent is dissolved;

(b) a step of mixing the first aqueous solution and the second aqueous solution with water in a subcritical or supercritical state to prepare a precursor of a transition metal oxide;

(c) a step of oxidizing all or part of the transition metals having the oxidation number below +3 contained in said precursor of the transition metal oxide so that they have an oxidation number of +3; and

(d) a step of mixing the resulting product of step (c) with a lithium precursor compound and then calcining the mixture.

If electrode plates are fabricated by using a single-phase lithium-deficient lithium multicomponent transition metal oxide of the present invention having a layered crystal structure as the electrode-active material, they have the advantages of high energy density, high capacity, high stability and long lifetime, because substantially all of the electrode-active materials participate in charge and discharge, and the whole area of the electrode plate uniformly participates in charge and discharge.

### BRIEF DESCRIPTION OF DRAWINGS

FIG. 1a is the solubility curves of an aluminum compound, a nickel compound, a cobalt compound, and a manganese compound depending on pH at 25° C. FIG. 1b is the solubility curves of various metal compounds depending on pH at 25° C.

FIG. 2 is the X-ray diffraction (XRD) pattern of the compound synthesized in Example 1.

FIG. 3 shows plots a, b, c, d, e, f, g, h, i, j, k, l, and m, which are Ni K-edge XANES spectra of NiO and the compounds synthesized in Comparative Example 1, Comparative Example 2, Comparative Example 3, Example 9, Example 1, Example 2, Example 3, Example 4, Example 5, Example 6, Example 7, and Example 8, respectively.

FIG. 4 shows plots a, b, c, d, and e, which are Fourier transform results for Ni K-edge EXAFS spectra of NiO and the compounds synthesized in Comparative Example 1, Example 1, Example 2, and Example 3, respectively.

FIG. 5 shows plots a, b, c, d, e, f, g, h, i, j, k, and l, which are Ni K-edge XANES spectra of the compounds synthesized in Comparative Example 1, Comparative Example 2, Comparative Example 3, Example 1, Example 2, Example 3, Example 4, Example 5, Example 6, Example 7, Example 8 and Example 9, respectively.

FIG. 6 shows plots a, b, c, and d, which are Fourier transform results for Ni K-edge EXAFS spectra of the compounds synthesized in Comparative Example 1, Example 1, Example 2, and Example 3, respectively.

FIG. 7 shows plots a, b, c, d, e, f and g, which are Co K-edge XANES spectra of the compounds synthesized in Comparative Example 1, Comparative Example 2, Comparative Example 3, Example 1, Example 2, Example 3 and Example 4, respectively.

FIG. 8 shows plots a and b, which are Fourier transform results for Co K-edge EXAFS spectra of the compounds synthesized in Comparative Example 1 and Example 1, respectively.

FIG. 9 is the charge/discharge graph at 0.2 C of a lithium secondary battery utilizing the compound synthesized in Example 1 as cathode-active material.

FIG. 10 is the XRD pattern of the compound synthesized in Example 2.

FIG. 11 is the charge/discharge graph at 0.2 C of a lithium secondary battery utilizing the compound synthesized in Example 2 as cathode-active material.

FIG. 12 is the XRD pattern of the compound synthesized in Example 3.

FIG. 13 is the XRD pattern of the compound synthesized in Example 4.

FIG. 14 is the XRD pattern of the compound synthesized in Example 5.

FIG. 15 is the XRD pattern of the compound synthesized in Example 6.

FIG. 16 is the XRD pattern of the compound synthesized in Example 7.

FIG. 17 is the XRD pattern of the compound synthesized in Example 8.

FIG. 18 is the XRD pattern of the compound synthesized in Example 9.

FIG. 19 is the charge/discharge graph at 0.2 C of a lithium secondary battery utilizing the compound synthesized in Example 9 as cathode-active material.

FIG. 20 is the XRD pattern of the compound synthesized in Comparative Example 1.

FIG. 21 shows the charge/discharge graphs at 0.1 C (thin solid line), 0.2 C (thick solid line), and 0.5 C ( ----- ) of a lithium secondary battery utilizing the compound synthesized in Comparative Example 1 as cathode-active material.

### DETAILED DESCRIPTION

The single-phase lithium-deficient lithium multicomponent transition metal oxides having a layered crystal structure are represented by the following chemical formula 1:

Li₁₋ₐM1_{1-x-y-z}M2ₓM3_{y}M4_{z}O₂ (1)

In chemical formula 1, M1 is one or more transition metal having an oxidation number of +3, M2 is one or more transition metal having an oxidation number of +4, M3 is one or more transition metal having an oxidation number of +5, M4 is one or more element having an oxidation number of +2, x+2y−z>0, x+y+z<1, 0<a<1, 0<x<0.75, 0≦y<0.6, and 0≦z<0.3.

In chemical formula 1, z may be 0≦z<0.2, 0≦z<0.1, 0.1≦z<0.2, or 0.2≦z<0.3.

The constituents of a compound represented by chemical formula 1 can be substituted with one or more elements selected from the group consisting of alkali metals except lithium, alkaline earth metals, and rare earth metals.

In addition, M1 can be one or more elements selected from the group consisting of Ni³⁺, Co³⁺, Al³⁺, Fe³⁺, Mn³⁺, Cr³⁺, Ti³⁺, V³⁺, Sc³⁺, Y³⁺, and La³⁺; M2 can be one or more elements selected from the group consisting of Ni⁴⁺, Co⁴⁺, Mn⁴⁺, Ti⁴⁺, and V⁴⁺; M3 can be one or more elements selected from the group consisting of V⁵⁺, Mn⁵⁺, Mo⁵⁺, and W⁵⁺; and M4 can be one or more elements selected from the group consisting of Ni²⁺, Co²⁺, Fe²⁺, Mn²⁺, Cr²⁺, V²⁺, Cu²⁺, Zn²⁺, Mg²⁺, Ca²⁺, and Sr²⁺.

Preferably, M1 is Ni³⁺ or the combination of Ni³⁺ and one or more transition metals having an oxidation number of +3. For such combination with Ni³⁺, transition metals can be selected from the group consisting of Ni³⁺, Co³⁺, Al³⁺, Fe³⁺, Mn³⁺, Cr³⁺, Ti³⁺, V³⁺, Sc³⁺, Y³⁺, and La³⁺.

Example compounds of chemical formula 1 include Li_{0.9}Ni_{0.8}³⁺Mn_{0.1}⁴⁺Co_{0.1}³⁺O₂, Li_{0.8}Ni_{0.6}³⁺Mn_{0.2}⁴⁺Co_{0.2}³⁺O₂, Li_{0.7}Ni_{0.5}³⁺Mn_{0.3}⁴⁺Co_{0.2}³⁺O₂, Li_{0.6}Ni_{0.4}³⁺Mn_{0.4}⁴⁺Co_{0.2}³⁺O₂, Li_{0.8}Ni_{0.7}³⁺Mn_{0.2}⁴⁺Fe_{0.1}³⁺O₂, Li_{0.7}Ni_{0.6}³⁺Mn_{0.3}⁴⁺Fe_{0.1}³⁺O₂, Li_{0.8}Ni_{0.6}³⁺Mn_{0.2}⁴⁺Al_{0.2}³⁺O₂, Li_{0.7}Ni_{0.5}³⁺Mn_{0.3}⁴⁺Al_{0.2}³⁺O₂, Li_{0.98}Ni_{0.72}³⁺Ni_{0.08}²⁺Mn_{0.1}⁴⁺Co_{0.1}³⁺O₂, Li_{0.86}Ni_{0.54}³⁺Ni_{0.06}²⁺Mn_{0.2}⁴⁺Co_{0.2}³⁺O₂, Li_{0.75}Ni_{0.45}³⁺Ni_{0.05}²⁺Mn_{0.3}⁴⁺Co_{0.2}³⁺O₂, Li_{0.64}Ni_{0.36}³⁺Ni_{0.04}²⁺Mn_{0.4}⁴⁺Co_{0.2}³⁺O₂, Li_{0.55}Ni_{0.45}³⁺Ni_{0.05}²⁺Mn_{0.5}⁴⁺O₂, Li_{0.98}Ni_{0.72}³⁺Ni_{0.08}²⁺Mn_{0.1}⁴⁺Fe_{0.1}³⁺O₂, Li_{0.86}Ni_{0.54}³⁺Ni_{0.06}²⁺Mn_{0.2}⁴⁺Fe_{0.2}³⁺O₂, Li_{0.75}Ni_{0.45}³⁺Ni_{0.05}²⁺Mn_{0.3}⁴⁺Fe_{0.2}³⁺O₂, Li_{0.64}Ni_{0.36}³⁺Ni_{0.04}²⁺Mn_{0.4}⁴⁺Fe_{0.2}³⁺O₂, Li_{0.98}Ni_{0.72}³⁺Ni_{0.08}²⁺Mn_{0.1}⁴⁺Al_{0.1}³⁺O₂, Li_{0.86}Ni_{0.54}³⁺Ni_{0.06}²⁺Mn_{0.2}⁴⁺Al_{0.2}³⁺O₂, Li_{0.75}Ni_{0.45}³⁺Ni_{0.05}²⁺Mn_{0.3}⁴⁺Al_{0.2}³⁺O₂, Li_{0.64}Ni_{0.36}³⁺Ni_{0.04}²⁺Mn_{0.4}⁴⁺Al_{0.2}³⁺O₂, Li_{0.68}Ni_{0.32}³⁺Ni_{0.08}²⁺Mn_{0.4}⁴⁺Co_{0.2}³⁺O₂, Li_{0.68}Ni_{0.32}³⁺Ni_{0.08}²⁺Mn_{0.4}⁴⁺Fe_{0.2}³⁺O₂, Li_{0.68}Ni_{0.32}³⁺Ni_{0.08}²⁺Mn_{0.4}⁴⁺Al_{0.2}³⁺O₂, Li_{0.92}Ni_{0.48}³⁺Ni_{0.12}²⁺Mn_{0.2}⁴⁺Co_{0.2}³⁺O₂, Li_{0.8}Ni_{0.4}³⁺Ni_{0.1}²⁺Mn_{0.3}⁴⁺Co_{0.2}³⁺O₂, Li_{0.6}Ni_{0.4}³⁺Ni_{0.1}²⁺Mn_{0.5}⁴⁺O₂, Li_{0.92}Ni_{0.48}³⁺Ni_{0.12}²⁺Mn_{0.2}⁴⁺Fe_{0.2}³⁺O₂, Li_{0.8}Ni_{0.4}³⁺Ni_{0.1}²⁺Mn_{0.3}⁴⁺Fe_{0.2}³⁺O₂, Li_{0.92}Ni_{0.48}³⁺Ni_{0.12}²⁺Mn_{0.2}⁴⁺Al_{0.2}³⁺O₂, Li_{0.8}Ni_{0.4}³⁺Ni_{0.1}²⁺Mn_{0.3}⁴⁺Al_{0.2}³⁺O₂, Li_{0.85}Ni_{0.35}³⁺Ni_{0.15}²⁺Mn_{0.3}⁴⁺O_{0.2}³⁺O₂, Li_{0.72}Ni_{0.28}³⁺Ni_{0.12}²⁺Mn_{0.4}⁴⁺Co_{0.2}³⁺O₂, Li_{0.65}Ni_{0.35}³⁺Ni_{0.15}²⁺Mn_{0.5}⁴⁺O₂, Li_{0.85}Ni_{0.35}³⁺Ni_{0.15}²⁺Mn_{0.3}⁴⁺Fe_{0.2}³⁺O₂, Li_{0.72}Ni_{0.28}³⁺Ni_{0.12}²⁺Mn_{0.4}⁴⁺Fe_{0.2}³⁺O₂, Li_{0.85}Ni_{0.35}³⁺Ni_{0.15}²⁺Mn_{0.3}⁴⁺Al_{0.2}³⁺O₂, Li_{0.72}Ni_{0.28}³⁺Ni_{0.12}²⁺Mn_{0.4}⁴⁺Al_{0.2}³⁺O₂, Li_{0.76}Ni_{0.24}³⁺Ni_{0.16}²⁺Mn_{0.4}⁴⁺Co_{0.2}³⁺O₂, Li_{0.76}Ni_{0.24}³⁺Ni_{0.16}²⁺Mn_{0.4}⁴⁺Fe_{0.2}³⁺O₂, Li_{0.76}Ni_{0.24}³⁺Ni_{0.16}²⁺Mn_{0.4}⁴⁺Al_{0.2}³⁺O₂, Li_{0.9}Ni_{0.3}³⁺Ni_{0.2}²⁺Mn_{0.3}⁴⁺Co_{0.2}³⁺O₂, Li_{0.7}Ni_{0.3}³⁺Ni_{0.2}²⁺Mn_{0.5}⁴⁺O₂, Li_{0.9}Ni_{0.3}³⁺Ni_{0.2}²⁺Mn_{0.3}⁴⁺Fe_{0.2}³⁺O₂, Li_{0.9}Ni_{0.3}³⁺Ni_{0.2}²⁺Mn_{0.3}⁴⁺Al_{0.2}³⁺O₂, Li_{0.95}Ni_{0.25}³⁺Ni_{0.25}²⁺Mn_{0.3}⁴⁺Co_{0.2}³⁺O₂, Li_{0.8}Ni_{0.2}³⁺Ni_{0.2}²⁺Mn_{0.4}⁴⁺Co_{0.2}³⁺O₂, Li_{0.75}Ni_{0.25}³⁺Ni_{0.25}²⁺Mn_{0.5}⁴⁺O₂, Li_{0.95}Ni_{0.25}³⁺Ni_{0.25}²⁺Mn_{0.3}⁴⁺Fe_{0.2}³⁺O₂, Li_{0.8}Ni_{0.2}³⁺Ni_{0.2}²⁺Mn_{0.4}⁴⁺Fe_{0.2}³⁺O₂, Li_{0.95}Ni_{0.25}³⁺Ni_{0.25}²⁺Mn_{0.3}⁴⁺Al_{0.2}³⁺O₂, and Li_{0.8}Ni_{0.2}³⁺Ni_{0.2}²⁺Mn_{0.4}⁴⁺Al_{0.2}³⁺O₂.

In chemical formula 1, the molar ratio of lithium ions represents lithium ions as a constituent of the single-phase lithium-deficient lithium multicomponent transition metal oxide having a layered crystal structure. In reality, in preparing lithium multicomponent transition metal oxides as electrode-active material, a lithium precursor compound is used as a reactant in an excessive amount in order to compensate for the lithium volatilized during a calcining procedure or to maximize the discharge capacity of a lithium secondary battery. Therefore, the molar ratio of the lithium ions contained in the resulting product may be higher than the molar ratio of lithium ions in chemical formula 1. However, the lithium ions introduced for the above purpose is not contained in a single-phase lithium-deficient lithium multicomponent transition metal oxide of the present invention having a layered crystal structure, but instead is present in the form of impurities having electrochemical activity.

The lithium-deficient compounds of the present invention can be used as electrode-active material.

Any of the conventional methods known in the field of electrode preparation can be used for preparing an electrode by using a lithium-deficient compound of the present invention. For example, an electrode can be prepared by mixing a lithium-deficient compound of the present invention as cathode-active material with a conducting agent and a binding agent to prepare an electrode slurry, and then by coating a current collector with the electrode slurry.

The present invention provides electrochemical devices which comprises (a) a cathode comprising a lithium-deficient compound of the present invention, (b) an anode, (c) a separator membrane, and (d) an electrolyte. Such electrochemical devices include all devices which undergo an electrochemical reaction, including various secondary batteries, fuel cells, solar batteries, memory devices, and capacitors such as a hybrid capacitor (P-EDLC), etc. Particularly, a compound of the present invention is suitable as a cathode-active material for lithium secondary batteries among secondary batteries, including lithium metal secondary batteries, lithium ion secondary batteries, lithium ion polymer secondary batteries or lithium metal polymer secondary batteries.

An electrochemical device of the present invention can be prepared by inserting a porous separator membrane between a cathode and an anode and then injecting an electrolyte, according to conventional methods known in the art.

An anode, electrolyte, and separator membrane to be used together with a cathode of the present invention are not particularly limited, and ordinary ones which can be used in conventional electrochemical devices can be used.

A single-phase lithium-deficient lithium multicomponent transition metal oxide having a layered crystal structure according to the present invention can be prepared by: obtaining a precursor of a multicomponent transition metal oxide which is uniformly mixed at an atomic level, based on hydrothermal synthesis using subcritical or supercritical water; converting all or part of the transition metals having an oxidation number less than +3 among the transition metals in the resulting precursor into an oxidation number of +3 through selective oxidation number control, wherein the selective oxidation is conducted to such an extent that the single-phase layered crystal structure is maintained; and mixing the resulting controlled product with a lithium precursor compound and then calcining the mixture.

Conventionally, lithium multicomponent transition metal oxides can be synthesized by various methods including a solid-state reaction method, molten salt sintering method, sol-gel method, spray pyrolysis method, coprecipitation-calcination method, etc. However, with such known methods, it is not easy to readily obtain a desired composition, uniform composition, or preferable oxidation state.

In such methods as solid-state reaction, molten salt sintering, sol-gel, and spray pyrolysis, wherein a lithium precursor compound participates from an early stage of the method, it is very difficult to selectively control the oxidation numbers of respective transition metals. Therefore, such methods do not produce desired single-phase lithium multicomponent transition metal oxides having a layered crystal structure, but produce mixtures or complexes comprising inert impurities and/or irreversibly oxidized/reduced materials, which are inferior as electrode materials. Further, in conventional lithium multicomponent transition metal oxides prepared by conventional methods, transition metals contained therein has a low uniformity, and, therefore, in serious events, only some local parts of a plate participate in charge/discharge as the charge/discharge progresses, causing local expansions or shrinkages possibly leading to the dismantlement of the cathode plate, thereby giving rise to such problems as the reduction of charge/discharge capacity and the shortening of battery lifetime.

In the case of production by a solid-phase reaction, although the raw materials of various transition metals can be mixed to a certain extent in the course of pulverizing and grinding down the raw materials for forming lithium multicomponent transition metal oxides, uniform mixing at an atomic level through such mechanical mixing is almost impossible. In addition, in a calcination procedure of a solid-phase reaction, it is very difficult to selectively control the oxidation numbers of respective transition metals to achieve optimal states. Since controlling to obtain optimal oxidation numbers is difficult even where calcination is conducted under an oxidation atmosphere, the production of impurities is not inhibited, or the solid solution, mixture or complexes referred to as lithium-excess compounds are produced.

As for production by a sol-gel method, since various transition metal salts are dissolved in a solvent and the transition metal ions are spontaneously uniformly mixed in the solution, the uniformity of multicomponent transition metals contained in the lithium multicomponent transition metal oxides is high, but it is also difficult to selectively control the oxidation numbers of respective transition metals to achieve optimal states during gelling and calcining procedures, as in production by a solid-phase reaction.

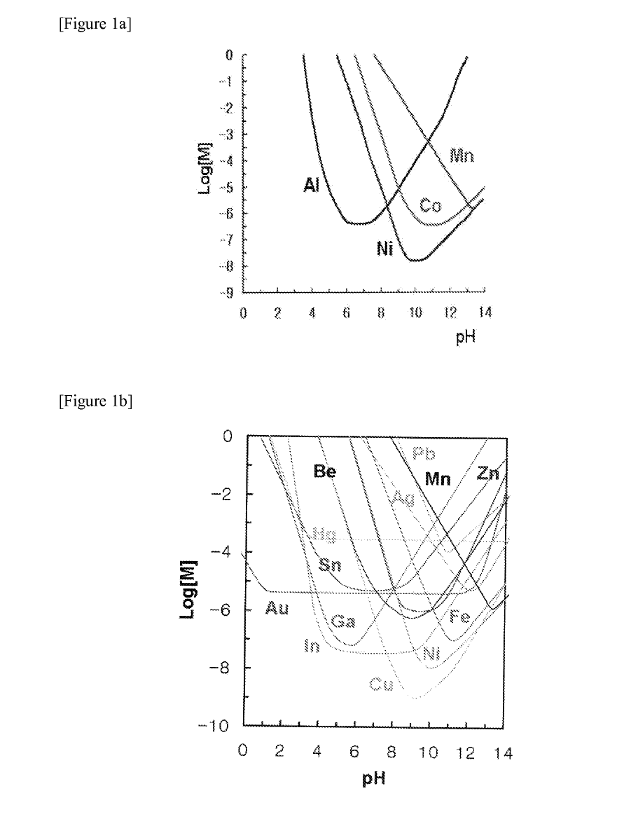

In the case of production by a coprecipitation-calcination method, as shown in FIG. 1a and FIG. 1b, the solubilities of transition metal hydroxides as precipitates greatly vary depending on transition metals under given co-precipitation conditions [Reference: Atlas of Electrochemical Equilibria in Aqueous Solutions, Marcel Pourbaix, Pergamon Press]. Therefore, when it is desired to obtain a lithium multicomponent transition metal oxide wherein the transition metals are present at certain ratios, it can never be obtained by co-precipitating the solutions of transition metal salts at the same ratios as those of the transition metals existing in the final oxides. Accordingly, the co-precipitation must be conducted by controlling the concentrations or amounts of the transition metals in the solution in consideration of differences in solubility between different transition metal hydroxides. However, although transition metals can be included in desired ratios in a co-precipitated product as a whole, differences in solubility between different transition metal hydroxides ultimately make the ratios of the transition metals deviate from the desired ones depending on the depth of precipitate particles, bringing about co-precipitation products wherein individual precipitation particles have different ratios of transition metals, and thereby resulting in a co-precipitation product lacking in solid solution properties. Therefore, lithium multicomponent transition metal oxides which are uniformly mixed at an atomic level cannot be obtained by a coprecipitation-calcination method.

As for a supercritical hydrothermal synthesis method, in the reaction of mixed multicomponent transition metal solutions with supercritical water, the solubilities of all reactants become temporarily zero. Therefore, uniformly mixed transition metals produce a multicomponent transition metal oxide in a moment without any changes in their mixing uniformity and mixing ratios, and thus it is possible to obtain a multicomponent transition metal oxide precursor which are uniformly mixed at an atomic level. Thus, based on hydrothermal synthesis using subcritical or supercritical water, the present invention prepares a desired single-phase lithium-deficient lithium multicomponent transition metal oxide having a layered crystal structure by: obtaining the precursor of the multicomponent transition metal oxide in which mixing is uniform at an atomic level; selectively changing the oxidation numbers of the transition metals of the multicomponent transition metal oxide precursor; and mixing the resulting product with a lithium precursor compound and then calcining the mixture.

The parameters which control the ratios of the components of lithium-deficient compounds according to the present invention include the concentration of the aqueous transition metal precursor compound solution, the concentration of the aqueous alkalizing agent solution, the concentration of the aqueous sodium hypochlorite solution, the concentration of the aqueous hydrogen peroxide solution, the pH of the mixed solution, the reaction temperature, the reaction pressure, the mole number of the lithium precursor compound, calcining conditions, etc. Therefore, the compositional ratio of a lithium-deficient lithium multicomponent transition metal oxide can be controlled by a combination of the above parameters.

One example method for preparing a lithium-deficient compound according to the present invention comprises (a) a step of preparing a first aqueous solution in which transition metals are dissolved, and a second aqueous solution in which an alkalizing agent is dissolved;

(b) a step of mixing said first aqueous solution and said second aqueous solution with water in a subcritical or supercritical state to prepare a precursor of a multicomponent transition metal oxide;

(c) a step of selectively oxidizing all or part of the transition metals having the oxidation number below +3 contained in said precursor of the multicomponent transition metal oxide to have an oxidation number of +3; and

(d) a step of mixing the resulting product of step (c) with a lithium precursor compound and then calcining the mixture.

Another example method for preparing a lithium-deficient oxide of the present invention comprises the steps of: (i) producing a first aqueous solution wherein a precursor compound of M1, a precursor compound of M2, a precursor compound of M3, and/or a precursor compound of M4 are dissolved (the first aqueous solution can be either a combination of aqueous solutions each of which comprises part of said precursor compounds dissolved therein, or can be a solution wherein all of the precursor compounds are dissolved in one solution) and a second aqueous solution wherein an alkalizing agent is dissolved; (ii) mixing said first aqueous solution and said second aqueous solution with water in a subcritical or supercritical state to produce the precursor of M1/M2/M3/M4 oxide, which is then cooled, washed, concentrated and/or dried; (iii) reacting the resulting product of step (ii) with an aqueous sodium hypochlorite solution of 0.0001-0.05M or a mixed solution thereof to which a diluted hydrogen peroxide solution is added if necessary, for 2-24 hours at a temperature of 50-100° C. under normal pressure in order to selectively oxidize transition metals contained in the product of step (ii) and washing, concentrating and drying the oxidized M1/M2/M3/M4 oxide precursor; and (iv) mixing the resulting product of step (iii) with a lithium precursor compound, and calcining the mixture.

Examples of the methods for preparing a lithium-deficient oxide of the present invention are more specifically explained below.

Step (a): Production of a first aqueous solution which contains precursor compounds of M1, M2, M3, and/or M4.

For the precursor compound of M1, the precursor compound of M2, the precursor compound of M3, and the precursor compound of M4, any compounds can be used without restriction as long as they can be ionized. Preferably, they are water-soluble compounds. Non-limiting examples of such precursor compounds include alkoxides, nitrates, acetates, halides, oxides, carbonates, oxalates, sulfates comprising transition metals, or salts comprising a combination thereof. Nitrates, sulfates, acetates, etc. are particularly preferable.

Step (b): Production of a second aqueous solution containing an alkalizing agent.

The concentration of the alkalizing agent dissolved in the second aqueous solution must be such that its mole number exceeds the molar sum of acidic groups (NO₃, SO₄, etc.) derived from M1, M2, M3 and M4 precursor compounds contained in the aqueous solution of step (a). Alkalizing agents are not specifically limited as long as they can make the reaction solution alkaline. Non-limiting examples of the alkalizing agent include alkali metal hydroxides (NaOH, KOH, etc.), alkaline earth metal hydroxides (Ca(OH)₂, Mg(OH)₂, etc.), ammonia compounds (ammonia solution, ammonium nitrate, etc.) or a mixture thereof.

Step (c): Production of precursors of M1/M2/M3/M4 oxides.

Said first aqueous solution and said second aqueous solution are introduced at the same flow rate into a mixer at normal temperature and a pressure of 180-550 bars, and mixed together with distilled water of 200-700° C., which is also introduced into the mixer at a higher flow rate 10-20 times the flow rate of the second aqueous solution, and the final mixture is retained in the reactor, which is kept at a temperature of 200-700° C. under a pressure of 180-550 bars, for 5-10 seconds to produce a precursor of M1/M2/M3/M4 oxide.

The mixing ratio of related materials in the reactor for producing the precursor of M1/M2/M3/M4 oxide, reaction pressure, and reaction temperature must be suitable so that the precursor of M1/M2/M3/M4 oxide can be prepared. Here, subcritical or supercritical conditions mean a state of a pressure of 180 to 550 bars at a high temperature in the range of 200 to 700° C. Preferably, the reactor is consistently maintained under subcritical or supercritical conditions, and desirably is a continuous reactor.

Step (d): Selectively controlling the oxidation numbers of the transition metals in the M1/M2/M3/M4 oxide precursor.

The resulting product of step (c) is reacted with an aqueous sodium hypochlorite solution having a concentration of 0.0001-0.05M for 2-24 hours at a temperature of 50-100° C. under normal pressure. A mixed solution wherein, if necessary, diluted hydrogen peroxide is added to said aqueous sodium hypochlorite solution in order to inhibit an excessive change of the oxidation numbers, is preferably reacted with the M1/M2/M3/M4 oxide precursor for 2-24 hours.

Selective control of oxidation number means that all or part of the transition metals having an oxidation number less than +3 among the multicomponent transition metals present in the M1/M2/M3/M4 oxide precursor is oxidized to an oxidation number of +3, to an extent that the single-phase layered crystal structure is maintained. The transition metals must be controlled to have an average oxidation number appropriately higher than +3. When the average oxidation number is lower than, or excessively higher than, +3, the mixture in which impurities co-exist is obtained as well as a single-phase lithium multicomponent transition metal oxide having a layered crystal structure.

Step (e): Production of a single-phase lithium-deficient lithium multicomponent transition metal oxide having a layered crystal structure by mixing the resulting product of step (d) with a lithium precursor compound and calcining the mixture.

Non-limiting examples of the lithium precursor compounds include Li₂Co₃, LiOH, LiF, or a mixture thereof.

The temperature range for a calcining procedure is not particularly limited, but is preferably 500 to 1,000° C. When the temperature is lower than 500° C., the resulting product does not have sufficient crystallinity and is not sufficiently stabilized, so that the properties of a battery such as charge/discharge capacity, battery lifetime, power output, etc., are deteriorated. When the temperature is higher than 1,000° C., disadvantages such as phase decomposition due to excessive sintering may arise.

A sintering aid can be used in order to lower a calcining temperature or increase a sintering density when the mixture of step (e) is calcined at a high temperature. Non-limiting examples thereof include metal oxides such as alumina, B₂O₃, MgO, etc., or precursors thereof, and Li compounds such as LiF, LiOH, Li₂Co₃, etc. A doping agent and a coating agent are used to dope the metal oxides inside the cathode-active material structure to improve durability when the product is used for a battery, or for coating the outside of crystals with ultrafine metal oxide particles. Non-limiting examples thereof include metal oxides such as alumina, zirconia, titania, magnesia, etc., or precursors thereof.

The present invention is explained in more detail by the following Examples and Comparative Examples. The following Examples are provided only to exemplify the present invention, and they are not intended to limit the scope of the present invention.

### Example 1

### Li_{0.9}Ni_{0.8}Mn_{0.1}Co_{0.1}O₂

0.8 mol of nickel nitrate (Ni(NO₃)₂.6H₂O), 0.1 mol of manganese nitrate (Mn(NO₃)₂.6H₂O), and 0.1 mol of cobalt nitrate (Co(NO₃)₂.6H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.9}Ni_{0.8}Mn_{0.1}Co_{0.1}O₂.

(a) A step of introducing each of the two aqueous solutions into a mixer at normal temperature and a pressure of 250 bars at a flow rate of 8 g/min, mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/cobalt oxide, which was then cooled, washed and concentrated to produce a slurry;

(b) A step of keeping the precursor slurry of step (a) in a 0.01 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/cobalt oxide.

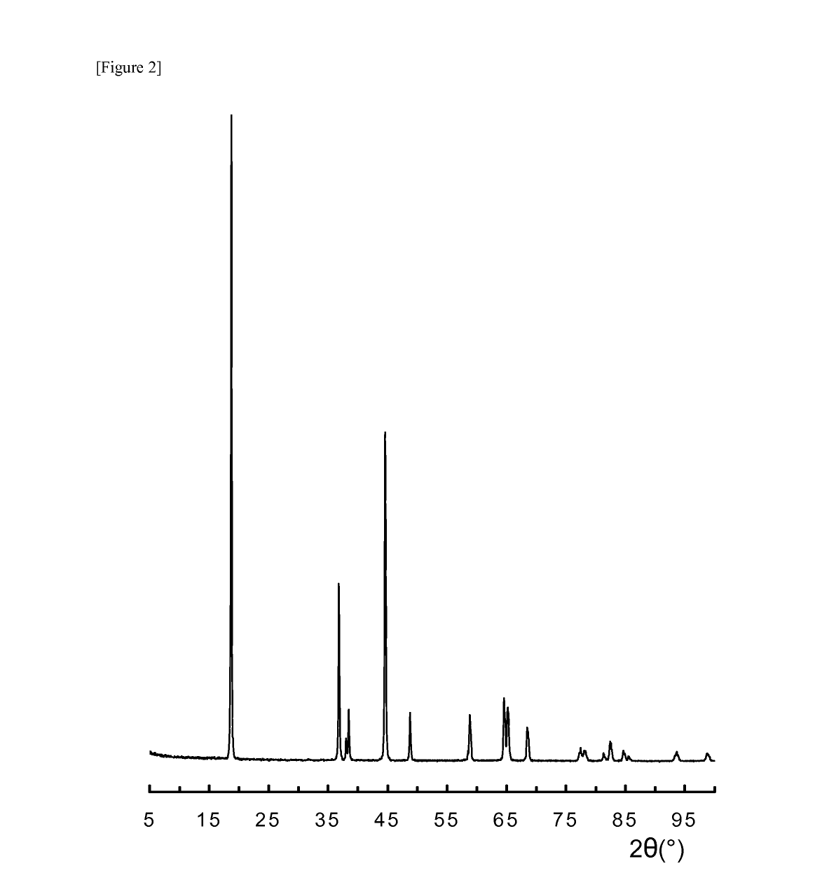

FIG. 2 shows the X-ray diffraction (XRD) pattern of the final product thus obtained. From the analysis of this XRD pattern, it can be confirmed that the final product is a crystal having the layered structure of the space group R-3m. From the fact that peaks at the (006) and (102) crystal faces in the area adjacent to 2θ of 38° do not overlap but are present as separate peaks, and peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy (ICP-AES) analysis confirmed that the molar ratios of nickel, manganese, and cobalt contained in said compound were 0.80, 0.10, and 0.10, respectively.

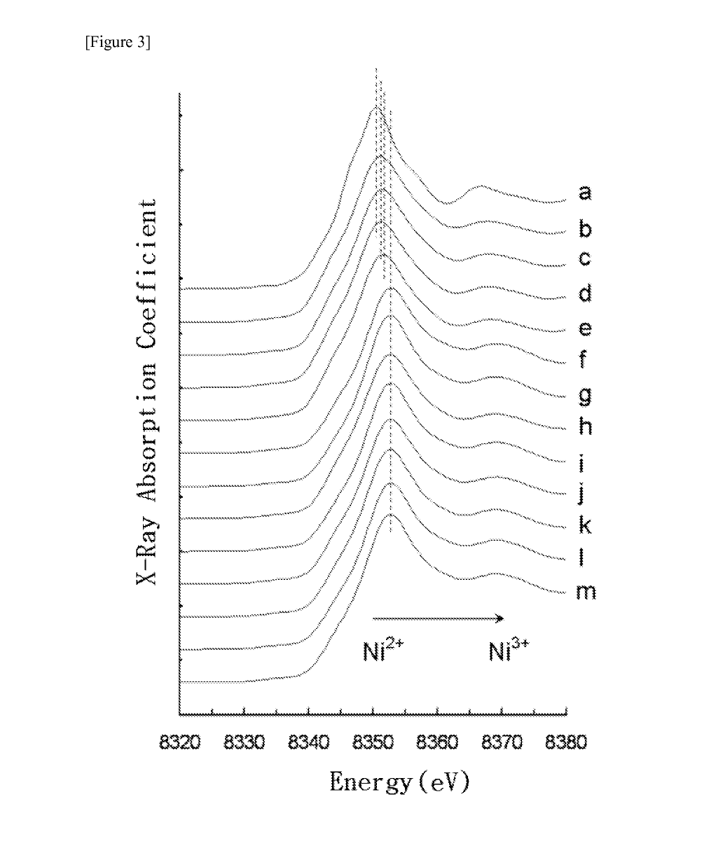

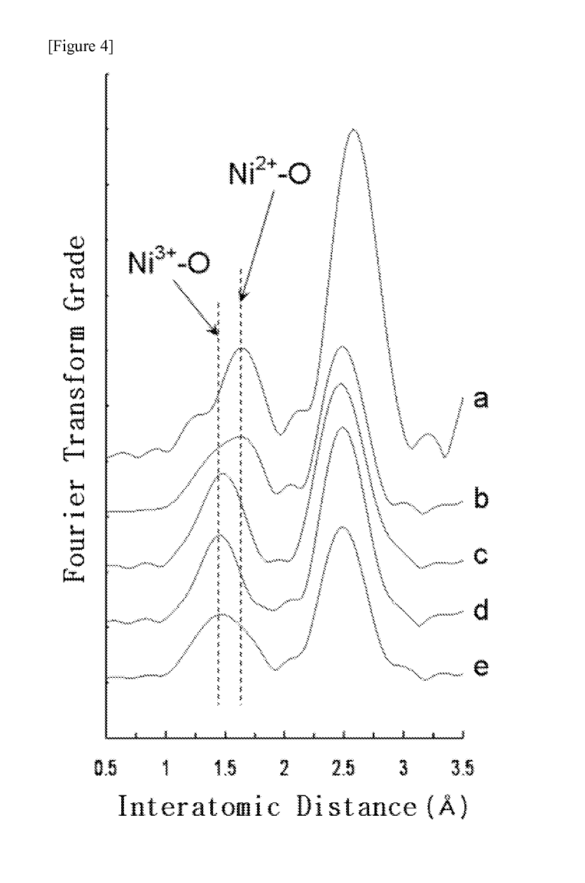

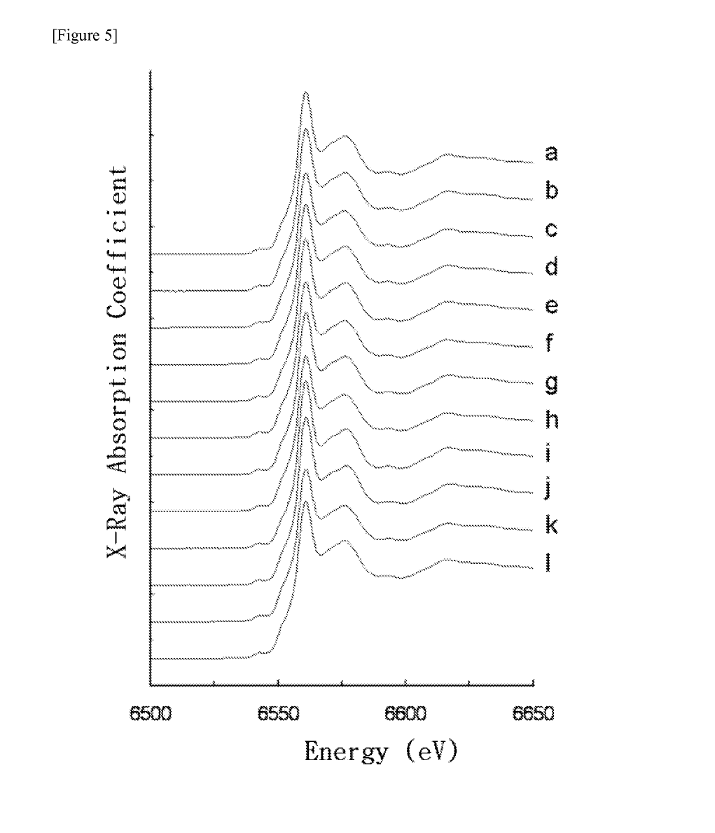

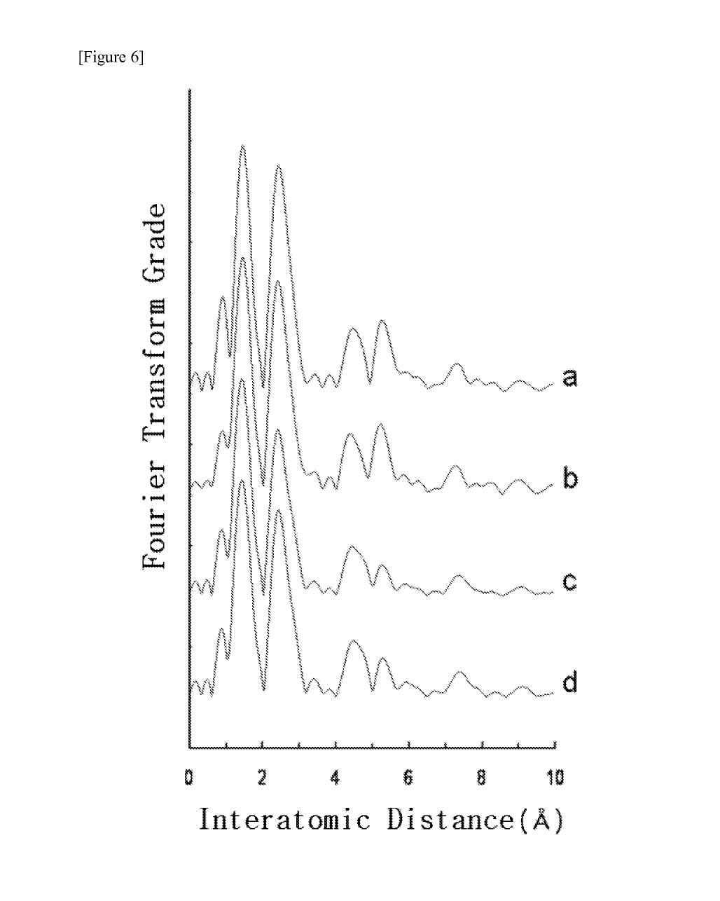

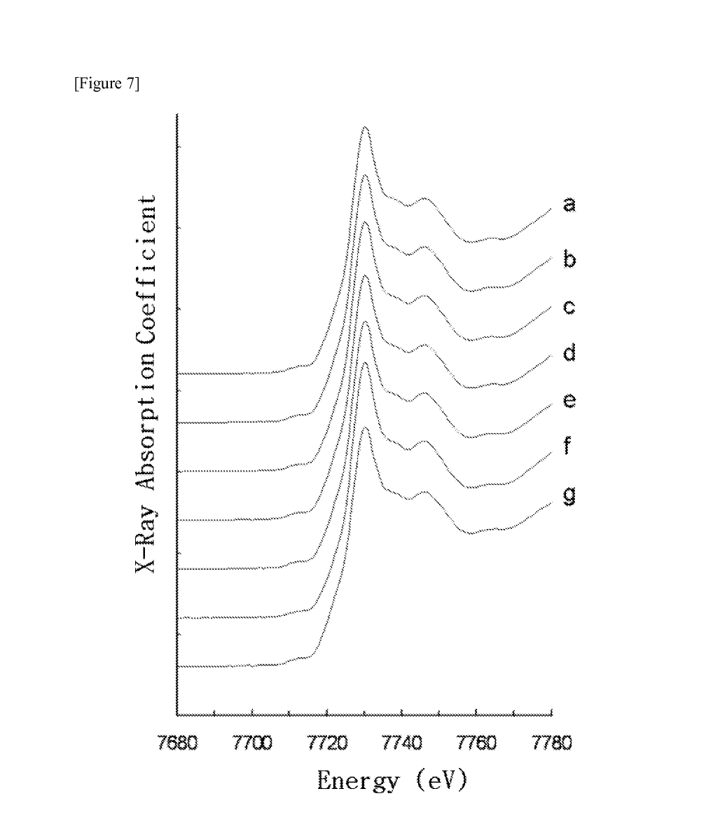

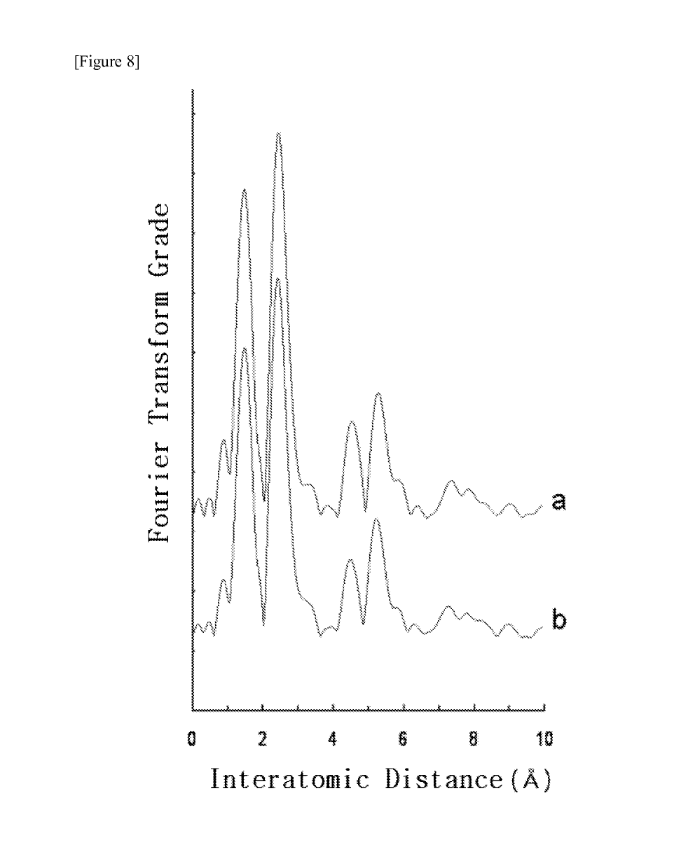

From measurement by X-ray absorption spectroscopy (XAS) (plots a, b, and c of FIG. 3, plots a, b, and c of FIG. 4, plots a and b of FIG. 5, plots a and b of FIG. 6, plots a and b of FIG. 7, and plots a and b of FIG. 8), which is the combination of X-ray Absorption Near Edge Structure (XANES) and Extended X-ray Absorption Fine Structure (EXAFS), it is confirmed that the oxidation numbers of nickel, manganese, and cobalt contained in said compound are +3, +4, and +3, respectively, and thus said compound is Li_{0.9}Ni_{0.8}Mn_{0.1}Co_{0.1}O₂. (As stated hereinabove, during processes for preparing a lithium-deficient lithium nickel/manganese/cobalt oxide, Li is added in an excessive amount for the purpose of maximizing the charge capacity and improving the charge/discharge efficiency of a lithium secondary battery. However, the molar ratio of Li in said compositional ratio of the nickel-deficient lithium nickel/manganese/cobalt oxide of the present invention is the one excluding the amount added excessively for the above purpose, i.e., it represents only the amount of Li as a constituent of said oxide. This principle also applies to the other examples set forth below.)

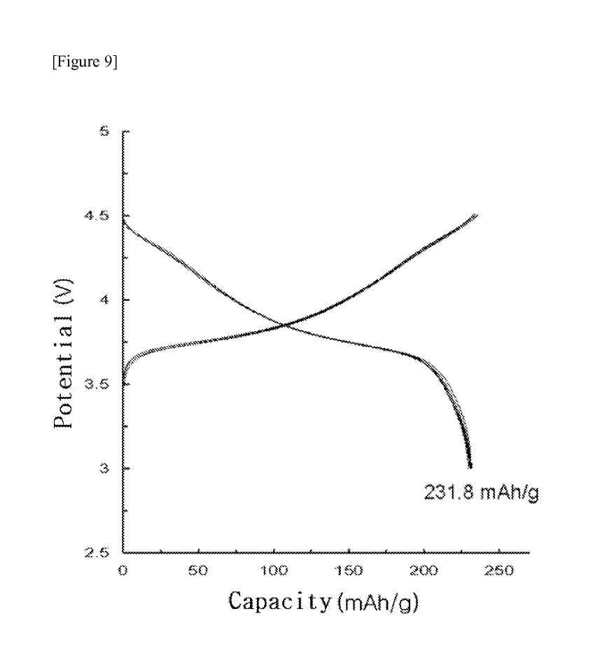

FIG. 9 is a charge/discharge graph at 0.2 C of a lithium secondary battery prepared by using the compound synthesized in Example 1, i.e., Li_{0.9}Ni_{0.8}Mn_{0.1}Co_{0.1}O₂, as cathode-active material, which shows excellent battery properties such as an initial discharge capacity of 231.8 mAh/g and a capacity retention rate of 99.1% after 50 charge/discharge cycles. Thus, said battery exhibits properties far superior to lithium secondary batteries which use the conventional compound Li_{1±δ}Ni_{1-x-y}MnₓCo_{y}O₂ as cathode-active material and show a discharge capacity of 150-180 mAh/g.

### Example 2

### Li_{0.8}Ni_{0.6}Mn_{0.2}Co_{0.2}O₂

0.6 mol of nickel nitrate (Ni(NO₃)₂.6H₂O), 0.2 mol of manganese nitrate (Mn(NO₃)₂.6H₂O), and 0.2 mol of cobalt nitrate (Co(NO₃)₂.6H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.8}Ni_{0.8}Mn_{0.2}Co_{0.2}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/cobalt oxide, which was then cooled, washed and concentrated to produce a slurry;

(b) A step of keeping the precursor slurry of step (a) in a 0.009 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/cobalt oxide.

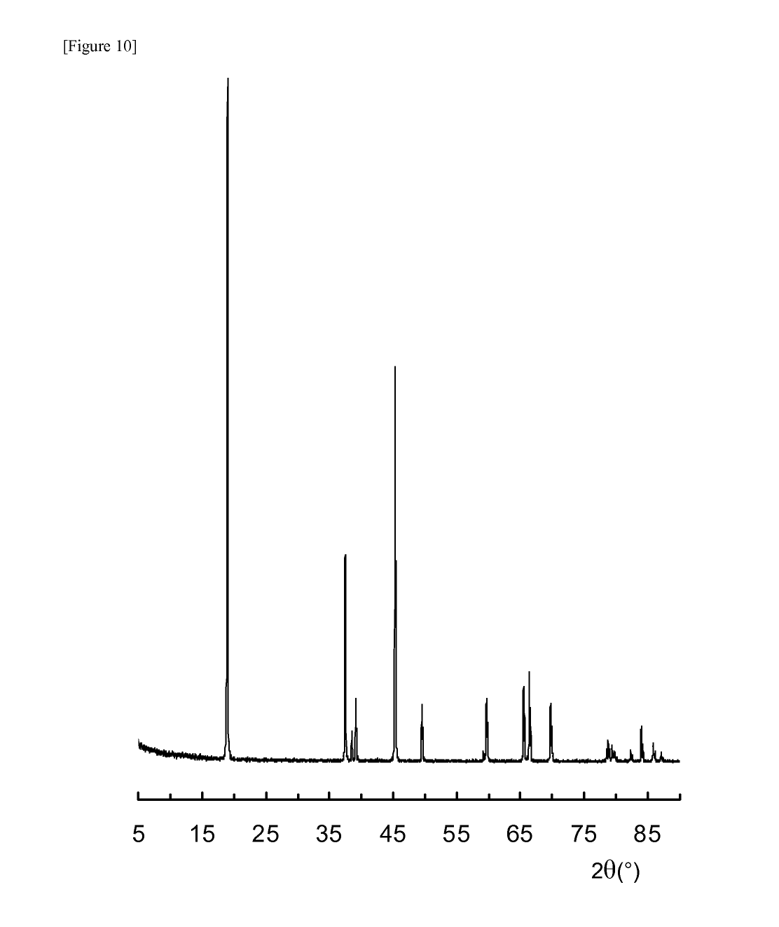

FIG. 10 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and cobalt contained in said compound were 0.60, 0.20 and 0.20, respectively.

From measurement results of XAS (plot f of FIG. 3, plot e of FIG. 5, and plot e of FIG. 7), which is the combination of XANES and EXAFS, it is confirmed that the oxidation numbers of nickel, manganese, and cobalt contained in said compound are +3, +4, and +3, respectively, and thus said compound is Li_{0.8}Ni_{0.6}Mn_{0.2}Co_{0.2}O₂.

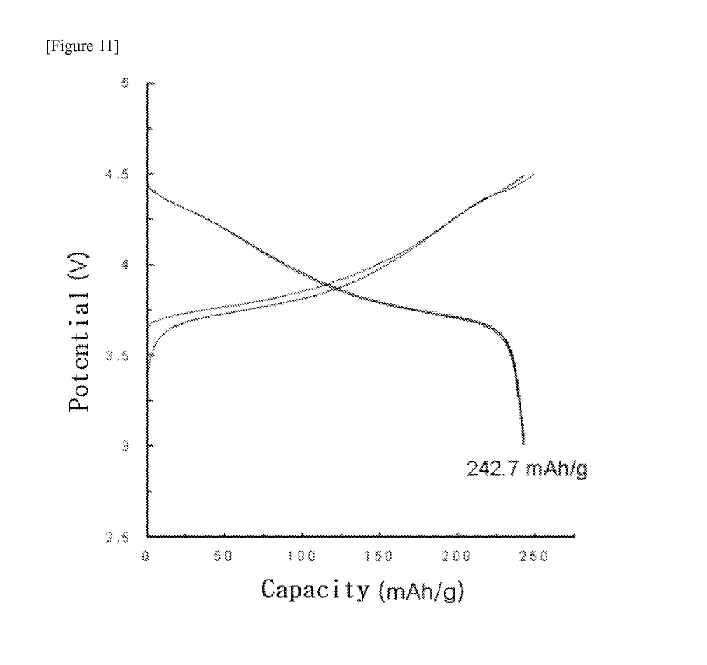

FIG. 11 is a charge/discharge graph at 0.2 C of a lithium secondary battery prepared by using the compound synthesized in Example 2, i.e. Li_{0.8}Ni_{0.6}Mn_{0.2}Co_{0.2}O₂, as cathode-active material, which shows excellent battery properties such as an initial discharge capacity of 242.7 mAh/g, and a capacity retention rate of 99.7% after 50 charge/discharge cycles. Thus, said battery exhibits properties far superior to lithium secondary batteries which use the conventional compound Li_{1±δ}Ni_{1-x-y}MnₓCo_{y}O₂ as cathode-active material and show a discharge capacity of 150-180 mAh/g.

### Example 3

### Li_{0.1}Ni_{0.5}Mn_{0.3}Co_{0.2}O₂

0.5 mol of nickel nitrate (Ni(NO₃)₂.6H₂O), 0.3 mol of manganese nitrate (Mn(NO₃)₂.6H₂O), and 0.2 mol of cobalt nitrate (Co(NO₃)₂.6H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.7}Ni_{0.5}Mn_{0.3}Co_{0.2}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/cobalt oxide, which was then cooled, washed and concentrated to produce a slurry;

(b) A step of keeping the precursor slurry of step (a) in a 0.008 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/cobalt oxide.

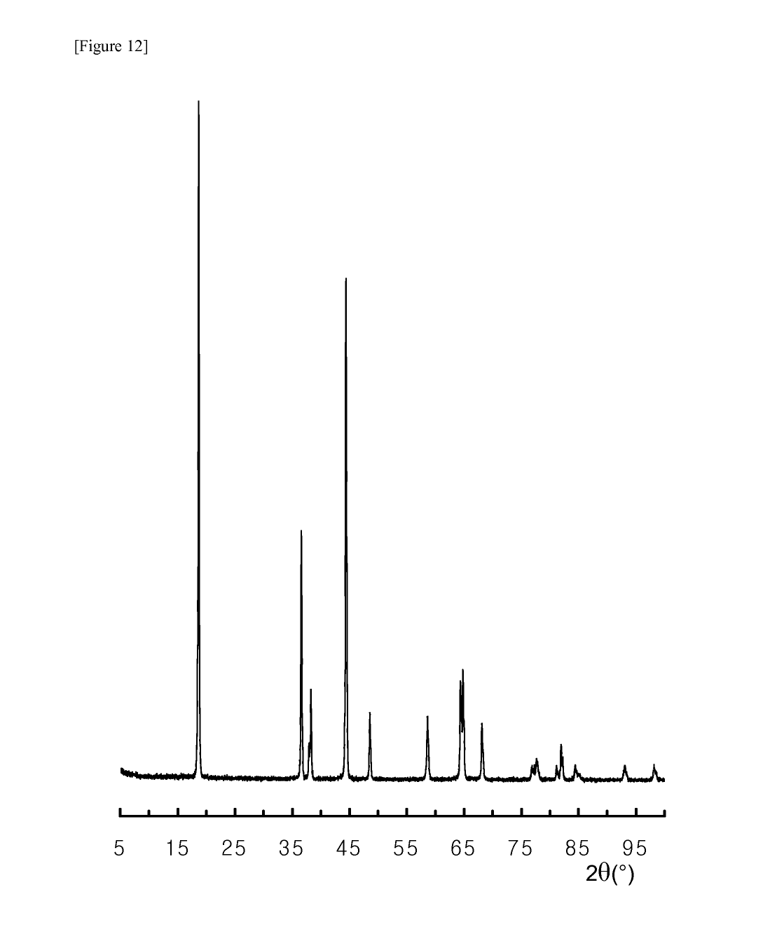

FIG. 12 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and cobalt contained in said compound were 0.50, 0.30 and 0.20, respectively.

From measurement results of XAS (plot d of FIG. 3, plot d of FIG. 4, plot c of FIG. 5, plot c of FIG. 6, and plot c of FIG. 7), which is the combination of XANES and EXAFS, it is confirmed that the oxidation numbers of nickel, manganese, and cobalt contained in said compound are +3, +4, and +3, respectively, and thus said compound is Li_{0.7}Ni_{0.5}Mn_{0.3}Co_{0.2}O₂.

### Example 4

### Li_{0.6}Ni_{0.4}Mn_{0.4}Co_{0.2}O₂

0.4 mol of nickel nitrate (Ni(NO₃)₂.6H₂O), 0.4 mol of manganese nitrate (Mn(NO₃)₂.6H₂O), and 0.2 mol of cobalt nitrate (Co(NO₃)₂.6H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.6}Ni_{0.4}Mn_{0.4}Co_{0.2}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/cobalt oxide, which was then cooled, washed and concentrated to produce a slurry;

(b) A step of keeping the precursor slurry of step (a) in a 0.007 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/cobalt oxide.

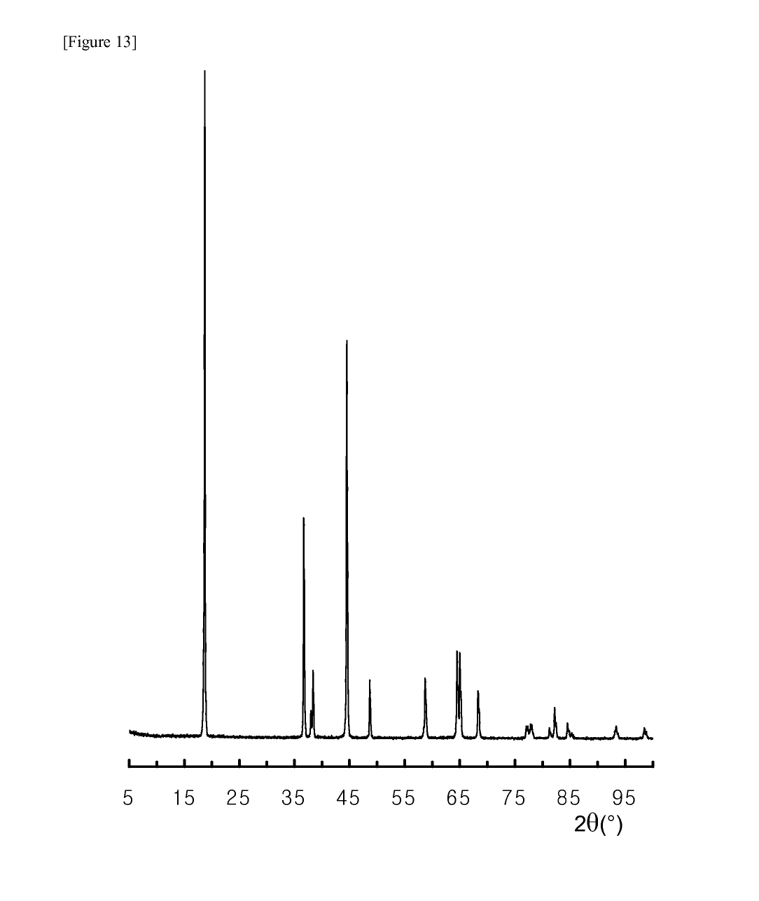

FIG. 13 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and cobalt contained in said compound were 0.40, 0.40, and 0.20, respectively.

From measurement results of XAS (plot e of FIG. 3, plot e of FIG. 4, plot d of FIG. 5, plot d of FIG. 6, and plot d of FIG. 7), which is the combination of XANES and EXAFS, it is confirmed that the oxidation numbers of nickel, manganese, and cobalt contained in said compound are +3, +4, and +3, respectively, and thus said compound is Li_{0.6}Ni_{0.4}Mn_{0.4}Co_{0.2}O₂.

### Example 5

### Li_{0.8}Ni_{0.7}Mn_{0.2}Fe_{0.1}O₂

0.7 mol of nickel nitrate (Ni(NO₃)₂.6H₂O), 0.2 mol of manganese nitrate (Mn(NO₃)₂.6H₂O), and 0.1 mol of ferrous sulfate (FeSO₄.7H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.8}Ni_{0.7}Mn_{0.2}Fe_{0.1}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/iron oxide, which was then cooled, washed and concentrated to produce a slurry;

(b) A step of keeping the precursor slurry of step (a) in an aqueous solution of 0.009 M sodium hypochlorite and 0.001 M hydrogen peroxide at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/iron oxide.

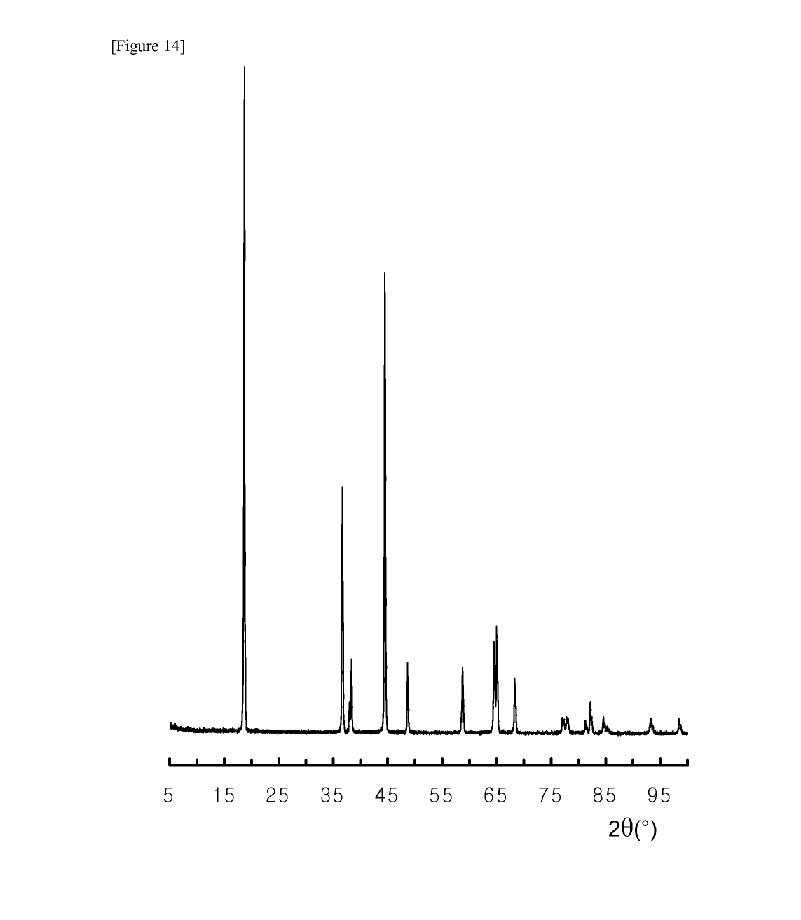

FIG. 14 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and iron contained in said compound were 0.70, 0.20 and 0.10, respectively.

From measurement results of XAS (plot g of FIG. 3 and plot f of FIG. 5), which is the combination of XANES and EXAFS, and results of EDTA (ethylenediaminetetra-acetic acid) titration and iodometry, it is confirmed that the oxidation numbers of nickel, manganese and iron contained in said compound are +3, +4, and +3, respectively, and thus said compound is Li_{0.8}Ni_{0.7}Mn_{0.2}Fe_{0.1}O₂.

### Example 6

### Li_{0.7}Ni_{0.6}Mn_{0.3}Fe_{0.1}O₂

0.6 mol of nickel nitrate (Ni(NO₃)₂.6H₂O), 0.3 mol of manganese nitrate (Mn(NO₃)₂.6H₂O), and 0.1 mol of ferrous sulfate (FeSO₄.7H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.7}Ni_{0.6}Mn_{0.3}Fe_{0.1}O₂.

(a) A step of introducing each of the two aqueous solutions into a mixer at normal temperature and a pressure of 250 bars at a flow rate of 8 g/min, and mixing together with distilled water of 450° C. which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/iron oxide, which was then cooled, washed and concentrated to produce a slurry;

(b) A step of keeping the precursor slurry of step (a) in an aqueous solution of 0.008 M sodium hypochlorite and 0.001 M hydrogen peroxide at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/iron oxide.

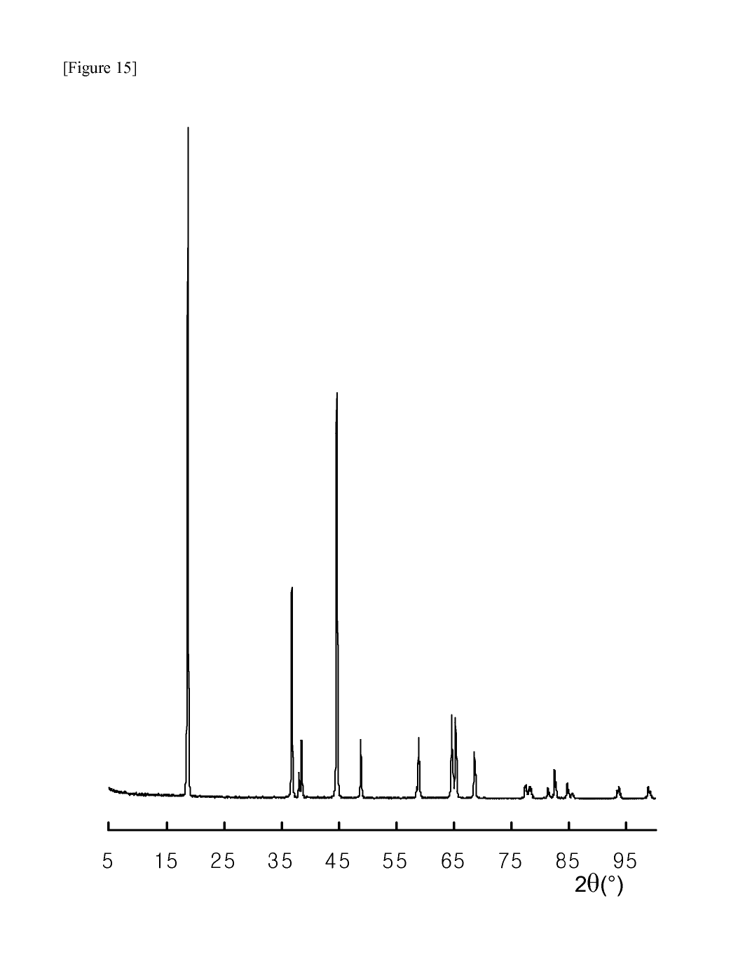

FIG. 15 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese and iron contained in said compound were 0.60, 0.30 and 0.10, respectively.

From measurement results of XAS (plot h of FIG. 3 and plot g of FIG. 5), which is the combination of XANES and EXAFS, and results of EDTA titration and iodometry, it is confirmed that the oxidation numbers of nickel, manganese, and iron contained in said compound are +3, +4, and +3, respectively, and thus said compound is Li_{0.7}Ni_{0.6}Mn_{0.3}Fe_{0.1}O₂.

### Example 7

### Li_{0.8}Ni_{0.6}Mn_{0.2}Al_{0.2}O₂

0.6 mol of nickel nitrate (Ni(NO₃)₂.6H₂O), 0.2 mol of manganese nitrate (Mn(NO₃)₂.6H₂O), and 0.2 mol of aluminum nitrate (Al(NO₃)₃.9H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.8}Ni_{0.6}Mn_{0.2}Al_{0.2}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/aluminum oxide, which was then cooled, washed and concentrated to produce a slurry;

(b) A step of keeping the precursor slurry of step (a) in a 0.009 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/aluminum oxide.

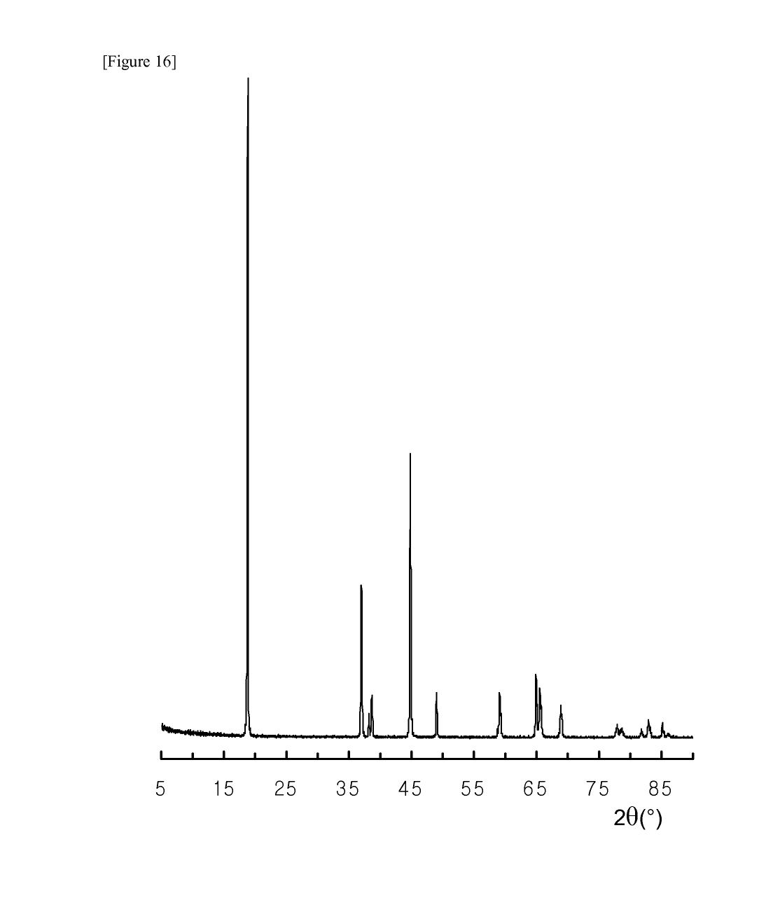

FIG. 16 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and aluminum contained in said compound were 0.60, 0.20 and 0.20, respectively.

From measurement results of XAS (plot i of FIG. 3 and plot h of FIG. 5), which is the combination of XANES and EXAFS, and results of EDTA titration and iodometry, it is confirmed that the oxidation numbers of nickel, manganese and aluminum contained in said compound are +3, +4, and +3, respectively, and thus said compound is Li_{0.8}Ni_{0.6}Mn_{0.2}Al_{0.2}O₂.

### Example 8

### Li_{0.1}Ni_{0.5}Mn_{0.3}Al_{0.2}O₂

0.5 mol of nickel nitrate (Ni(NO₃)₂.6H₂O), 0.3 mol of manganese nitrate (Mn(NO₃)₂.6H₂O), and 0.2 mol of aluminum nitrate (Al(NO₃)₃.9H₂O) were dissolved in distilled water to prepare a first aqueous solution. 140.18 g of a 25% aqueous ammonia solution as an alkalizing agent was diluted to prepare a second aqueous solution.

The two aqueous solutions were processed in the order of the following steps (a), (b), and (c) to prepare Li_{0.7}Ni_{0.5}Mn_{0.3}Al_{0.2}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese/aluminum oxide, which was then cooled, washed and concentrated to produce a slurry;

(b) A step of keeping the precursor slurry of step (a) in a 0.008 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese/aluminum oxide.

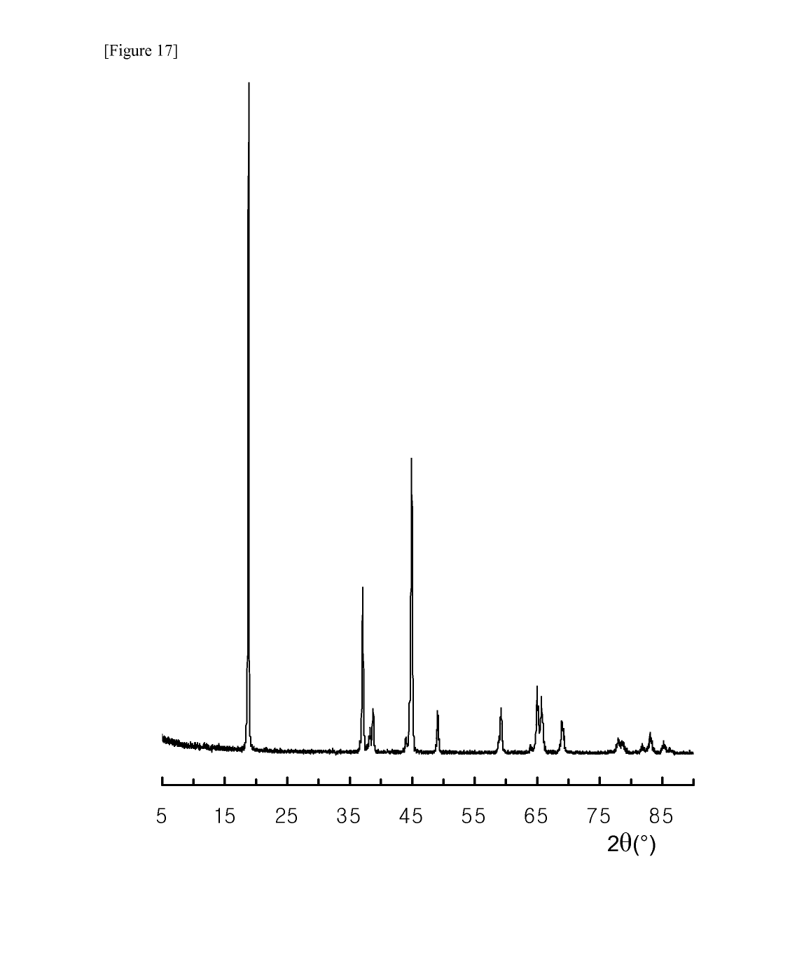

FIG. 17 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel, manganese, and aluminum contained in said compound were 0.50, 0.30 and 0.20, respectively.

From measurement results of XAS (plot j of FIG. 3 and plot i of FIG. 5), which is the combination of XANES and EXAFS, and results of EDTA titration and iodometry, it is confirmed that the oxidation numbers of nickel, manganese and aluminum contained in said compound are +3, +4, and +3, respectively, and thus said compound is Li_{0.7}Ni_{0.5}Mn_{0.3}Al_{0.2}O₂.

### Example 9

### Li_{0.73}Ni_{0.5}Mn_{0.5}O₂

0.5 mol of nickel nitrate (Ni(NO₃)₂.6H₂O) and 0.5 mol of manganese nitrate (Mn(NO₃)₂.6H₂O) were dissolved in distilled water to prepare a first aqueous solution. 140.18 g of a 25% aqueous ammonia solution as the alkalizing agent was diluted to prepare a second aqueous solution.

The two aqueous solutions were processed in the order of the following steps (a), (b), and (c) to prepare Li_{0.73}Ni_{0.5}Mn_{0.5}O₂.

(a) A step of introducing each of the two aqueous solutions into a mixer at normal temperature and a pressure of 250 bars at a flow rate of 8 g/min, and mixing together with distilled water of 450° C., which was introduced into the mixer at a flow rate of 96 g/min, and retaining the final mixture in the reactor, which was kept at a temperature of 400° C. under a pressure of 250 bars, for 5-10 seconds to produce a precursor of nickel/manganese oxide, which was then cooled, washed and concentrated to produce a slurry;

(b) A step of keeping the precursor slurry of step (a) in a 0.007 M aqueous sodium hypochlorite solution at 80° C. under normal pressure for 5 hours, and then washing, concentrating and drying the slurry; and

(c) A step of mixing the resulting product of step (b) with 0.525 mol of lithium carbonate (Li₂Co₃) and then calcining the mixture at 950° C. under an oxygen atmosphere for 10 hours to obtain a lithium-deficient lithium nickel/manganese oxide.

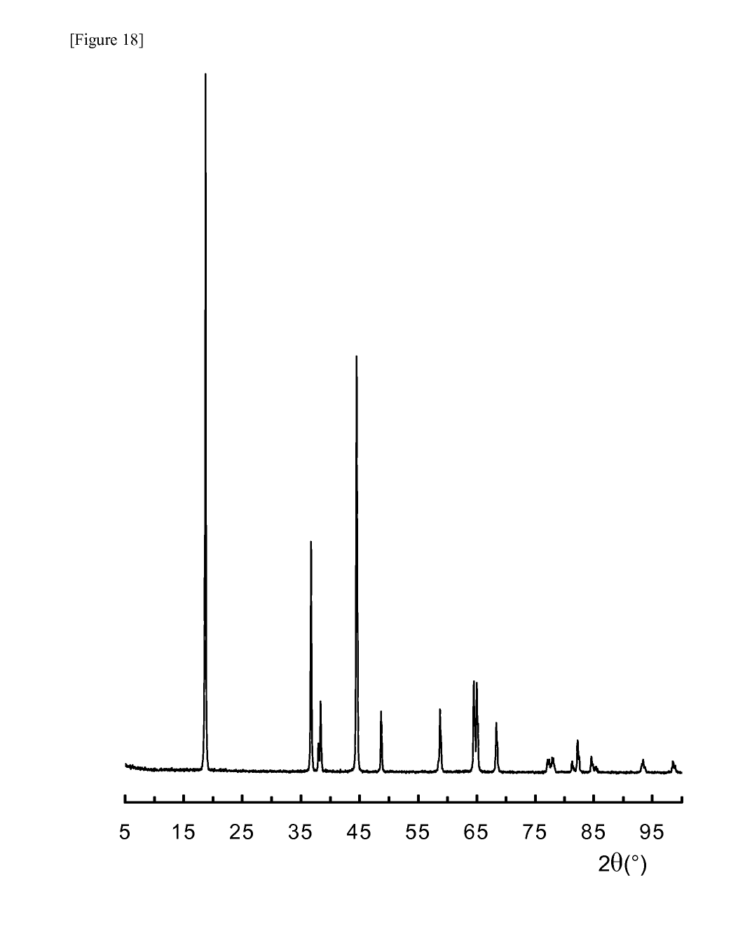

FIG. 18 shows the XRD pattern of the final product thus obtained. From the analysis of this XRD pattern, it can be confirmed that the final product is a crystal having the layered structure of the space group R-3m. From the fact that the peaks at the (006) and (102) crystal faces in the area adjacent to 2θ of 38° do not overlap but are present as separate peaks, and the peaks at the (108) and (110) crystal faces in the area adjacent to 2θ of 65° do not overlap but are present as separate peaks, it can be seen that the product has a very high crystallinity and has a single phase. In addition, an inductively coupled plasma-atomic emission spectroscopy analysis confirmed that the molar ratios of nickel and manganese contained in said compound were 0.50 and 0.50, respectively.

From measurement results of XAS (plot e of FIG. 3 and plot l of FIG. 5), which is the combination of XANES and EXAFS, and results of EDTA titration and iodometry, it is confirmed that the oxidation numbers of nickel and manganese contained in said compound are +2.54 and +4, respectively, and thus said compound is Li_{0.73}Ni_{0.5}Mn_{0.5}O₂.

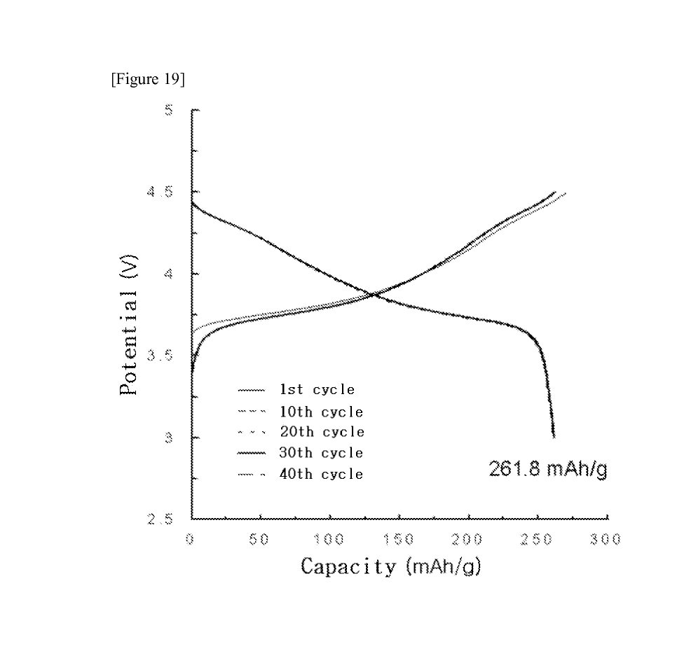

FIG. 19 is a charge/discharge graph at 0.2 C of a lithium secondary battery prepared by using the compound synthesized in Example 9, i.e. Li_{0.73}Ni_{0.5}Mn_{0.5}O₂, as cathode-active material, which shows excellent battery properties such as an initial discharge capacity of 261.8 mAh/g, and a capacity retention rate of 99.8% after 40 charge/discharge cycles.

### Comparative Example 1

### A Compound Having the Apparent Chemical Formula Li_{1.15}Ni_{0.61}Mn_{0.20}Co_{0.19}O₂

A first aqueous solution was prepared by mixing an aqueous sodium hydroxide solution with an ammonia solution and adjusting the mixture to a pH of about 13, and it was placed in a reactor. A second aqueous solution was prepared by mixing nickel sulfate, manganese nitrate, and cobalt sulfate in the ratios of 1.2 mol/dm³, 0.4 mol/dm³ and 0.4 mol/dm³, respectively. The first aqueous solution in the reactor was vigorously stirred while the second aqueous solution and an ammonia solution were added dropwise thereto to generate precipitates, and then washing, filtering and drying were performed to obtain a nickel/manganese/cobalt co-precipitate precursor. The resulting nickel/manganese/cobalt co-precipitate precursor and the lithium precursor compound were mixed in the molar ratio of 1:1.05 and calcined at a temperature of 950° C. under an oxygen atmosphere for 10 hours to obtain a lithium nickel/manganese/cobalt oxide.

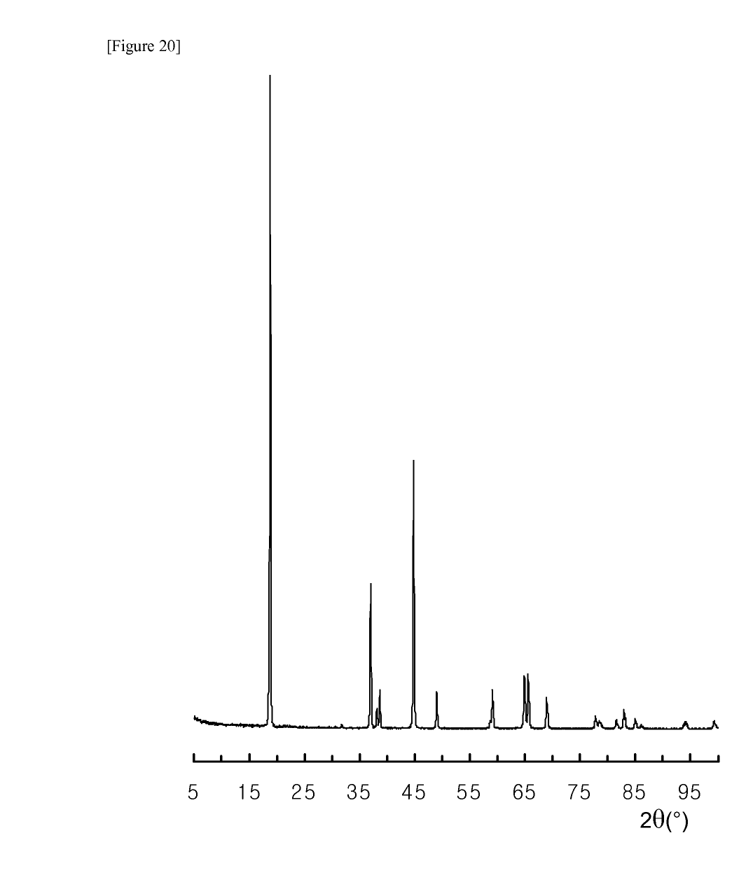

FIG. 20 shows the XRD pattern of the final product thus obtained. From the analysis of this XRD pattern, it can be confirmed that the final product is a crystal having a layered structure. In addition, an inductively coupled plasma-atomic emission spectroscopy analysis confirmed that the molar ratios of nickel, manganese, and cobalt contained in said compound were 0.61, 0.20 and 0.19, respectively.

From measurement results of XAS (plot b of FIG. 3, plot a of FIG. 5, and plot a of FIG. 7), which is the combination of XANES and EXAFS, and results of EDTA titration and iodometry, it is confirmed that the oxidation numbers of nickel, manganese, and cobalt contained in said compound are +2.42, +4, and +3, respectively. Accordingly, the apparent chemical formula of said compound is Li_{1.15}Ni_{0.61}Mn_{0.20}Co_{0.19}O₂ if only the electroneutrality requirement is considered.

The production method of Comparative Example 1 is the same as many conventional methods including the prior art techniques mentioned hereinabove, and the product prepared by the method has an average oxidation number of +2.852, which is lower than +3 required for electroneutrality. This means that although the product was prepared under an oxygen atmosphere, 58% of the total nickel on a mole number basis maintained its oxidation number of 2.

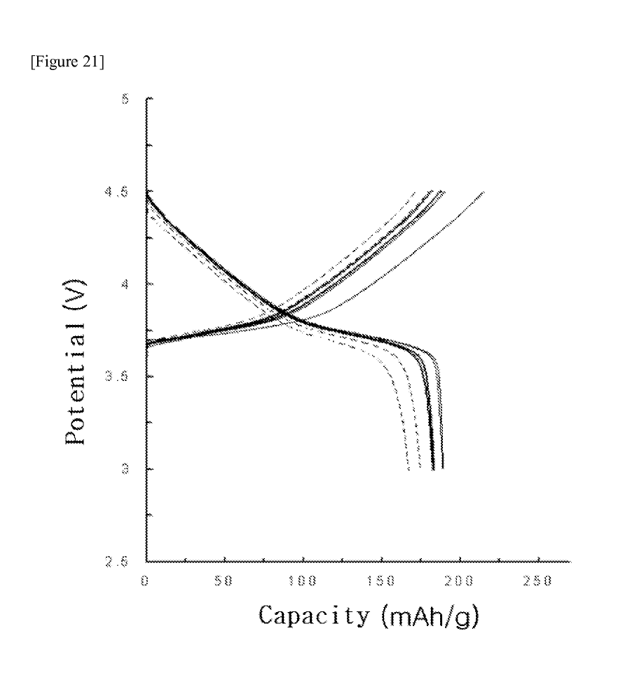

FIG. 21 shows charge/discharge graphs at 0.1 C, 0.2 C, 0.5 C of a lithium secondary battery prepared by using the compound synthesized by a coprecipitation-calcination method in Comparative Example 1, i.e. Li_{1+δ}Ni_{0.6}Mn_{0.2}Co_{0.2}O₂, as cathode-active material, which shows a discharge capacity of 183.4 mAh/g at 0.2 C, which greatly differs by 25% from a discharge capacity at 0.2 C of 242.7 mAh/g achieved by Li_{0.8}Ni_{0.6}Mn_{0.2}Co_{0.2}O₂ which was synthesized in Example 2 by using the same ratios of transition metals. This suggests the possibility that a difference in the oxidation number of nickel can lead to a difference in battery properties.

### Comparative Example 2

### A Compound Having the Apparent Chemical Formula Li_{1.94}Ni_{0.6}Mn_{0.2}Co_{0.2}O₂

Lithium acetate, nickel acetate, manganese acetate, and cobalt acetate in a molar ratio of 1.05:0.6:0.2:0.2 were dissolved in a mixture of distilled water and acrylic acid to obtain a mixed aqueous solution. The resulting mixed aqueous solution was gelled, dried, and then calcined at 500° C. for 3 hours and at 950° C. for 10 hours to obtain a lithium nickel/manganese/cobalt oxide. All of the gelation, drying, and calcining were conducted under an oxygen atmosphere.

An inductively coupled plasma-atomic emission spectroscopy analysis was conducted to confirm that the molar ratios of nickel, manganese, and cobalt contained in said compound were 0.60, 0.20 and 0.20, respectively.

From measurement results of XAS (plot c of FIG. 3, plot b of FIG. 5, and plot b of FIG. 7), which is the combination of XANES and EXAFS, and results of EDTA titration and iodometry, it is confirmed that the oxidation numbers of nickel, manganese, and cobalt contained in said compound are +2.43, +4, and +3, respectively. Accordingly, the apparent chemical formula of said compound is Li_{1.14}Ni_{0.6}Mn_{0.2}Co_{0.2}O₂ if only the electroneutrality requirement is considered.

### Comparative Example 3

### A Compound Having the Apparent Chemical Formula Li_{1.13}Ni_{0.6}Mn_{0.2}Co_{0.2}O₂

Lithium acetate, nickel acetate, manganese acetate, and cobalt acetate were mixed in a molar ratio of 1.05:0.6:0.2:0.2. The mixture was dried in a vacuum oven at 150° C. for 3 hours to obtain a precursor. The precursor was calcined at 500° C. for 3 hours and at 950° C. for 10 hours under an oxygen atmosphere to obtain a lithium nickel/manganese/cobalt oxide.

An inductively coupled plasma-atomic emission spectroscopy analysis was conducted to confirm that the molar ratios of nickel, manganese, and cobalt contained in said compound were 0.60, 0.20 and 0.20, respectively.

From measurement results of XAS (plot d of FIG. 3, plot c of FIG. 5, plot c of FIG. 7), which is the combination of XANES and EXAFS, and results of EDTA titration and iodometry, it is confirmed that the oxidation numbers of nickel, manganese, and cobalt contained in said compound are +2.45, +4, and +3, respectively. Accordingly, the apparent chemical formula of said compound is Li_{1.13}Ni_{0.6}Mn_{0.2}Co_{0.2}O₂ if only the electroneutrality requirement is considered.

A lithium-deficient oxide of the present invention can be used in various secondary batteries, fuel cells, solar batteries, memory devices, and capacitors such as hybrid capacitor (P-EDLC), etc. Particularly, they are suitable as cathode-active material for lithium secondary batteries among secondary batteries, including lithium metal secondary batteries, lithium ion secondary batteries, lithium ion polymer secondary batteries or lithium metal polymer secondary batteries.

1. A single-phase lithium-deficient lithium multicomponent transition metal oxide which has a layered crystal structure and is represented by the following chemical formula 1:
Li₁₋ₐM1_{1-x-y-z}M2ₓM3_{y}M4_{z}O₂ (1)
wherein M1 is one or more transition metals having an oxidation number of +3; M2 is one or more transition metals having an oxidation number of +4; M3 is one or more transition metals having an oxidation number of +5; M4 is one or more elements having an oxidation number of +2; x+2y−z>0; x+y+z<1; 0<a<1; 0<x<0.75; 0≦y<0.6; and 0=z<0.3.

2. The single-phase lithium-deficient lithium multicomponent transition metal oxide of claim 1, wherein M1 is Ni³⁺ or the combination of Ni³⁺ and one or more transition metals having an oxidation number of +3.

3. The single-phase lithium-deficient lithium multicomponent transition metal oxide of claim 1, wherein z is 0≦z<0.2.

4. The single-phase lithium-deficient lithium multicomponent transition metal oxide of claim 1, wherein z is 0≦z<0.1.

5. The single-phase lithium-deficient lithium multicomponent transition metal of claim 1, wherein z is 0.1≦z<0.2.

6. The single-phase lithium-deficient lithium multicomponent transition metal oxide of claim 1, wherein z is 0.2≦z<0.3.

7. The single-phase lithium-deficient lithium multicomponent transition metal oxide of claim 1, wherein M1 is one or more elements selected from the group consisting of Ni³⁺, Co³⁺, Al³⁺, Fe³⁺, Mn³⁺, Cr³⁺, Ti³⁺, V³⁺, Sc³⁺, Y³⁺, and La³⁺; M2 is one or more elements selected from the group consisting of Ni⁴⁺, Co⁴⁺, Mn⁴⁺, Ti⁴⁺, and V⁴⁺; M3 is one or more elements selected from the group consisting of V⁵⁺, Mn⁵⁺, Mo⁵⁺, and W⁵⁺; and M4 is one or more elements selected from the group consisting of Ni²⁺, Co²⁺, Fe²⁺, Mn²⁺, Cr²⁺, V²⁺, Cu²⁺, Zn²⁺, Mg²⁺, Ca²⁺, and Sr²⁺.

8. The single-phase lithium-deficient lithium multicomponent transition metal oxide of claim 1, which is selected from the group consisting of Li_{0.9}Ni_{0.8}³⁺Mn_{0.1}⁴⁺Co_{0.1}³⁺O₂, Li_{0.8}Ni_{0.6}³⁺Mn_{0.2}⁴⁺Co_{0.2}³⁺O₂, Li_{0.7}Ni_{0.5}³⁺Mn_{0.3}⁴⁺Co_{0.2}³⁺O₂, Li_{0.6}Ni_{0.4}³⁺Mn_{0.4}⁴⁺Co_{0.2}³⁺O₂, Li_{0.8}Ni_{0.7}³⁺Mn_{0.2}⁴⁺Fe_{0.1}³⁺O₂, Li_{0.7}¹Ni_{0.6}³⁺Mn_{0.3}⁴⁺Fe_{0.1}³⁺O₂, Li_{0.8}Ni_{0.6}³⁺Mn_{0.2}⁴⁺Al_{0.2}³⁺O₂, Li_{0.7} Ni_{0.5}³⁺Mn_{0.3}⁴⁺Al_{0.2}³⁺O₂, Li_{0.98}Ni_{0.72}³⁺Ni_{0.08}²⁺Mn_{0.1}⁴⁺Co_{0.1}³⁺O₂, Li_{0.86}Ni_{0.54}³⁺Ni_{0.06}²⁺Mn_{0.2}⁴⁺Co_{0.2}³⁺O₂, Li_{0.75}Ni_{0.45}³⁺Ni_{0.05}²⁺Mn_{0.3}⁴⁺Co_{0.2}³⁺O₂, Li_{0.64}Ni_{0.36}³⁺Ni_{0.04}²⁺Mn_{0.4}⁴⁺Co_{0.2}³⁺O₂, Li_{0.55}Ni_{0.45}³⁺Ni_{0.05}²⁺Mn_{0.5}⁴⁺O₂, Li_{0.98}Ni_{0.72}³⁺Ni_{0.08}²⁺Mn_{0.1}⁴⁺Fe_{0.1}³⁺O₂, Li_{0.86}Ni_{0.54}³⁺Ni_{0.06}²⁺Mn_{0.2}⁴⁺Fe_{0.2}³⁺O₂, Li_{0.75}Ni_{0.45}³⁺Ni_{0.05}²⁺Mn_{0.3}⁴⁺Fe_{0.2}³⁺O₂, Li_{0.64}Ni_{0.36}³⁺Ni_{0.04}²⁺Mn_{0.4}⁴⁺Fe_{0.2}³⁺O₂, Li_{0.98}Ni_{0.72}³⁺Ni_{0.08}²⁺Mn_{0.1}⁴⁺Al_{0.1}³⁺O₂, Li_{0.86}Ni_{0.54}³⁺Ni_{0.06}²⁺Mn_{0.2}⁴⁺Al_{0.2}³⁺O₂, Li_{0.75}Ni_{0.45}³⁺Ni_{0.05}²⁺Mn_{0.3}⁴⁺Al_{0.2}³⁺O₂, Li_{0.64}Ni_{0.36}³⁺Ni_{0.04}²⁺Mn_{0.4}⁴⁺Al_{0.2}O₂, Li_{0.68}Ni_{0.32}³⁺Ni_{0.08}²⁺Mn_{0.4}⁴⁺Co_{0.2}³⁺O₂, Li_{0.68}Ni_{0.32}³⁺Ni_{0.08}²⁺Mn_{0.4}⁴⁺Fe_{0.2}³⁺O₂, and Li_{0.68}Ni_{0.32}³⁺Ni_{0.08}²⁺Mn_{0.4}⁴⁺Al_{0.2}³⁺O₂.

9. The single-phase lithium-deficient lithium multicomponent transition metal oxide of claim 1, which is selected from the group consisting of Li_{0.92}Ni_{0.48}³⁺Ni_{0.12}²⁺Mn_{0.2}⁴⁺Co_{0.2}³⁺O₂, Li_{0.8}Ni_{0.4}³⁺Ni_{0.1}²⁺Mn_{0.3}⁴⁺Co_{0.2}³⁺O₂, Li_{0.6}Ni_{0.4}³⁺Ni_{0.1}²⁺Mn_{0.5}⁴⁺O₂, Li_{0.92}Ni_{0.48}³⁺Ni_{0.12}²⁺Mn_{0.2}⁴⁺Fe_{0.2}³⁺O₂, Li_{0.8}Ni_{0.4}³⁺Ni_{0.1}²⁺Mn_{0.3}⁴⁺Fe_{0.2}³⁺O₂, Li_{0.92}Ni_{0.48}³⁺Ni_{0.12}²⁺Mn_{0.2}⁴⁺Al_{0.2}³⁺O₂, Li_{0.8}Ni_{0.4}³⁺Ni_{0.1}²⁺Mn_{0.3}⁴⁺Al_{0.2}³⁺O₂, Li_{0.85}Ni_{0.35}³⁺Ni_{0.15}²⁺Mn_{0.3}⁴⁺Co_{0.2}³⁺O₂, Li_{0.72}Ni_{0.28}³⁺Ni_{0.12}²⁺Mn_{0.4}⁴⁺Co_{0.2}³⁺O₂, Li_{0.65}Ni_{0.35}³⁺Ni_{0.15}²⁺Mn_{0.5}⁴⁺O₂, Li_{0.85}Ni_{0.35}³⁺Ni_{0.15}²⁺Mn_{0.3}⁴⁺Fe_{0.2}³⁺O₂, Li_{0.72}Ni_{0.28}³⁺Ni_{0.12}²⁺Mn_{0.4}⁴⁺Fe_{0.2}³⁺O₂, Li_{0.85}Ni_{0.35}³⁺Ni_{0.15}²⁺Mn_{0.3}⁴⁺Al_{0.2}³⁺O₂, Li_{0.72}Ni_{0.28}³⁺Ni_{0.12}²⁺Mn_{0.4}⁴⁺Al_{0.2}³⁺O₂, Li_{0.76}Ni_{0.24}³⁺Ni_{0.16}²⁺Mn_{0.4}⁴⁺Co_{0.2}³⁺O₂, Li_{0.76}Ni_{0.24}³⁺Ni_{0.16}²⁺Mn_{0.4}⁴⁺Fe_{0.2}³⁺O₂, and Li_{0.76}Ni_{0.24}³⁺Ni_{0.16}²⁺Mn_{0.4}⁴⁺Al_{0.2}³⁺O₂.

10. The single-phase lithium-deficient lithium multicomponent transition metal oxide of claim 1, which is selected from the group consisting of Li_{0.9}Ni_{0.3}³⁺Ni_{0.2}²⁺Mn_{0.3}⁴⁺Co_{0.2}³⁺O₂, Li_{0.7}Ni_{0.3}³⁺Ni_{0.2}²⁺Mn_{0.5}⁴⁺O₂, Li_{0.9}Ni_{0.3}³⁺Ni_{0.2}²⁺Mn_{0.3}⁴⁺Fe_{0.2}³⁺O₂, Li_{0.9}Ni_{0.3}³⁺Ni_{0.2}²⁺Mn_{0.3}⁴⁺Al_{0.2}³⁺O₂, Li_{0.95}Ni_{0.25}³⁺Ni_{0.25}²⁺Mn_{0.3}⁴⁺Co_{0.2}³⁺O₂, Li_{0.8}Ni_{0.2}³⁺Ni_{0.2}²⁺Mn_{0.4}⁴⁺Co_{0.2}³⁺O₂, Li_{0.75}Ni_{0.25}³⁺Ni_{0.25}²⁺Mn_{0.5}⁴⁺O₂, Li_{0.95}Ni_{0.25}³⁺Ni_{0.25}²⁺Mn_{0.3}⁴⁺Fe_{0.2}³⁺O₂, Li_{0.8}Ni_{0.2}³⁺Ni_{0.2}²⁺Mn_{0.4}⁴⁺Fe_{0.2}³⁺O₂, Li_{0.95}Ni_{0.25}³⁺Ni_{0.25}²⁺Mn_{0.3}⁴⁺Al_{0.2}³⁺O₂, and Li_{0.8}Ni_{0.2}³⁺Ni_{0.2}²⁺Mn_{0.4}⁴⁺Al_{0.2}³⁺O₂.

11. An electrode comprising the single-phase lithium-deficient lithium multicomponent transition metal oxide of claim 1 as electrode-active material.

12. A secondary battery, fuel cell, solar battery, memory device, or capacitor comprising the single-phase lithium-deficient lithium multicomponent transition metal oxide of claim 1 as electrode-active material.

13. A method for preparing a single-phase lithium-deficient lithium multicomponent transition metal oxide which has a layered crystal structure and is represented by the following chemical formula 1:
Li₁₋ₐM1_{1-x-y-z}M2ₓM3_{y}M4_{z}O₂ (1)
wherein M1 is one or more transition metals having an oxidation number of +3; M2 is one or more transition metals having an oxidation number of +4; M3 is one or more transition metals having an oxidation number of +5; M4 is one or more elements having an oxidation number of +2; x+2y−z>0; x+y+z<1; 0<a<1; 0<x<0.75; 0≦y<0.6; and 0≦z<0.3, which method comprises the following steps:
(a) a step of preparing a first aqueous solution in which transition metals are dissolved, and a second aqueous solution in which an alkalizing agent is dissolved;
(b) a step of mixing said first aqueous solution and said second aqueous solution with water in a subcritical or supercritical state to prepare a precursor of a transition metal oxide;
(c) a step of oxidizing all or part of the transition metals having the oxidation number below +3 contained in said precursor of the transition metal oxide so that they have an oxidation number of +3; and
(d) a step of mixing the resulting product of step (c) with a lithium precursor compound and then calcining the mixture.
